(19) United States
(12) Patent Application Publication
(10) Pub. No.: US 2009/0063232 A1
(43) Pub. Date: Mar. 5, 2009

(54) REAL ESTATE LEAD INCUBATION SYSTEM

(76) Inventors: Michael Lissack, Naples, FL (US); Crispin Olson, Arlington, MA (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/848,984

(22) Filed: Aug. 31, 2007

(51) Int. Cl. G06Q 10/00

(52) U.S. Cl. 705/8; 705/7

(57) ABSTRACT

A system for lead incubation is used to alert an agent and to customize contacts with leads generated by an internet form, return mail form, voicemail, or telephone inquiry. For example, a lead may be interested in purchasing real estate, which requires a long lead incubation period. The system dynamically and recursively classifies the lead according to actions taken by the lead, requests made by the lead, and interactions between the lead and the system and/or agent. Based on heuristic patterns and triggers, the system provides suggestions to the agent for marketing campaigns for a lead or a class of leads, and alerts the agent when action or contact between the agent and the lead is recommended. The system is customizable by lead, by agent performance and/or by class of lead.

### FIELD OF THE INVENTION

The field is real estate sales, especially real estate sales leads generated by prospects who fill out internet contact forms.

### BACKGROUND

The Internet has become a useful tool for many to browse, discover what is available in the world, and to look to see what they might consider purchasing.

With respect to real estate, the Internet attracts several kinds of users: those just looking, those just curious about their neighbors home value, a prospective seller doing research, and a prospective buyer considering a home purchase. A prospective buyer may be at the beginning, middle or end of their process, the first time that the prospective buyer lands on a website.

It is common knowledge, and taught in any number of courses, that a real estate agent's time is best spent on leads that purchase a home within a six week window. Any prospective buyer who does not purchase a home within a period of a few weeks should be given up as a lost cause.

Here is representative advice given to real estate agents:
The “low-hanging-fruit” in real estate sales are those transactions which are the easiest to close. They could be repeat or referral customers, investors or relocation clients, those that require the least involvement for the biggest payoff.
Although this notion may seem a bit contrary to the survival mentality of “beggars can't be choosers”, if you sell in a market environment that lacks inventory, your quickest transaction will be directly tied to the discovery and procurement of a property to list. Conversely, in a buyers market your quickest transaction remains a client who needs to purchase quickly, such as inbound relocation. www.realtyu.com/real_estate_test.htm, ALISO VIEJO, Calif., Jul. 10, 2006

Why is such emphasis made on focusing on the quick sale? Because the costs in time and lost opportunity of dealing with a buyer in an early stage of research is just too great. So the advice goes, especially in a slow, buyer's market, focus on the buyers who need to purchase quickly in order to make sales. In a seller's market, focus on the sellers who need or want to make a quick sale. Regardless, focus on repeat, referral, investors or relocating buyers and sellers. “Those that require the least involvement for the biggest payoff.” This is the common wisdom known and taught to all real estate professionals.

FIG. 2 shows a timeline for a typical buyer and seller who starts research using the internet. Clearly, representing sellers is preferred, under the low hanging fruit philosophy prevalent in the real estate industry (at least if the market is a sellers market or a neutral market). And of the sellers represented, the hot prospects are those actually in the 2.4 month selling phase. The hot prospects amongst buyers are those in the 4.1 month buying phase.

Industry research shows that fifty percent of the buyers who start their home search on the internet will eventually purchase a home, but few, if any, of these early leads will be captured by current real estate best practices. Indeed, current real estate best practices teach away from expending much time or effort on these early leads, which simply require too much time and energy of the real estate agent.

FIG. 3 reinforces this philosophy of pick the low hanging fruit. Specifically, the email conversion rate is only 2.35 purchases for each 1000 emails sent. The idea is to disregard the vast majority of hits and to focus on those 2 or 3 individuals out of 1000 that are able to be converted easily.

Auto dealerships have very different closing and marketing strategies than real estate agencies. For example, auto dealerships always represent the seller. Even “pre-owned” auto dealers have no trouble in finding cars to sell, because there is always a robust trade-in and wholesale market. As a result, car dealers have long focused on the “low hanging fruit” of the auto market, their repeat customers and customers who are ready to buy (today, if possible). There is less profit per transaction and even more emphasis on closing the deal as soon as possible. FIG. 4 shows that most leads are closed within two months. The bell curve of FIG. 5 shows that most dealerships are only able to close 8-14% of leads. 44% of leads are not closed and do not make a purchase from any known dealer, as shown in FIG. 6. Furthermore, FIG. 6 shows that of the 56% of leads that make a purchase in the auto industry, 92% are not closed by the dealer receiving the lead but by some other dealer. It is not surprising, then, that auto dealers focus on those 8-14% that they believe are going to make a purchase within a week or so of entering their dealership. But this auto dealer philosophy has permeated the real estate market and other sales professions, which do not necessarily share much in common with auto sales.

It is believed, without being limiting in any way, that 58% of internet leads for real estate agents choose the first realtor who responds to them. On average, a real estate lead will visit 5 websites and complete 3 sign-up forms. Research shows that 90% of consumers are very satisfied when personally contacted on the same day that they complete an internet form. Business Week reports that 80% of leads from completing a sign-up form are lost, discarded or otherwise never responded to. Of the 20% who receive a response, 75% receive the response after twenty-four hours. Only 25% of the 20% (i.e. 5% of all leads) receive a response within 24 hours, according to Business Week. From these statistics, it is clear that little emphasis is placed on internet leads and responsiveness to these leads, even though 58% of internet leads for real estate agents choose the first realtor who responds to them.

Why is this? It is believed, without being limiting in any way, that the pervasive philosophy of “picking the low hanging fruit” so dominates the sales culture that internet leads are discounted. After all, the initial inquiry on the internet might require a 16 month incubation time, on average, prior to making a sale. This runs so far afoul of the six week rule in real estate that it is difficult to have any continuity in developing and incubating internet leads.

### SUMMARY OF THE INVENTION

A system incubates real estate sales leads generated when a prospect fills out an internet sign up form. The system builds a relationship with a potential buyer (or seller) using an automated system that requires less effort than known systems in order to close a greater percentage of sales from internet real estate leads.

One advantage of the system is that the system incubates leads over a long duration without requiring much time on the part of the agent assigned the lead. Thus, the lost opportunity cost is reduced and the lead conversion rate is increased. An agent may incubate internet leads over a long duration without substantially interfering with current sales, for example.

Another advantage is the system is tailored to the needs and desires of the buyer (or seller), which helps to build a relationship and dialog between the buyer and a virtual agent or agent's assistant.

Yet another advantage of one example of a system is that the system builds trust between the lead and a buyer's broker.

Yet another advantage is that the system commences a dialog between the lead and the agent, allowing the agent to establish preferences and to determine when the lead is ready, such as when a buyer is ready to buy a home. Dialog may be a two-way interactive communication without placing a burden on the agent's time. The system permits the agent to hear what a lead has to say to the system, to see what the lead is doing on the system in easy to review reports, to be aware of the leads interests, such as price points, time horizons, and the like, and to contact the lead when the lead is ready to buy (or sell) a home.

In one example, the system may include a limit on the number of agents in any market, such as by multiple listing service. For example, the system may be made available to only three percent of the agents/brokers in each multiple listing service in order to give the agent/broker who uses the system a competitive advantage.

A system for lead incubation by a real estate agent or broker may comprise various subsystems interoperably coupled on a single computer system or server, across a network of computer systems, within a peer to peer network and/or on the internet or otherwise. For example, the system couples a subsystem for capturing information about leads, a subsystem for tracking interactions between the leads and the systems, a subsystem for scheduling prepared telephone scripts, emails, letters, or combinations thereof, and a subsystem for alerting the agent or broker to contact one or more of the leads. The subsystem for capturing information about leads may provide for entry of leads into a database directly by a person, automatic porting of leads from a file or CRM, automatic entry of leads from an internet form, or any combination thereof. The subsystem for tracking interactions may include a personalized website. A unique identifier for accessing the personalized website, such as a unique user identifier or a unique website identifier, may be provided for each of leads. Then, the tracking system is capable of easily determining when an email is read by one or more specific leads. The tracking system may record the viewing of one or more listings by any of the leads. Tracking subsystems may track any combination of activities of any number of leads. Subsystems for scheduling and alerting may be used to adjust the scheduling and content of the alerts, which may be identified to any of the leads based on activity of the leads tracked in the subsystem for tracking or information captured in the subsystem for capturing.

In one example, the subsystem of alerting includes defining a plurality of categories for leads, assigning leads to one of the plurality of categories, and instructing the real estate agent or broker of a follow-up action to take for each of the plurality of categories. If a category fails to have at least one of the leads assigned to the category, then the category may be omitted and no alerts may be provided for the omitted category, in one example. The step of assigning leads may compare information obtained about each of the leads in the subsystem for tracking with the definition of each of the plurality of categories defined in the step of defining categories. The step of defining categories may define a range for a particular criteria or criterias. one or more of the leads may be assigned to one of the plurality of categories based on information known about the leads from the system.

In one example, a lead is assigned to a category only if information about the lead fits within the definition defined in the step of defining categories, and the initial definitions may be provided by system defaults. However, the initial system defaults may be modified. For example, system defaults may be customizable by the real estate agent or broker or the lead, himself or herself. In one example, definitions of each of the categories may be adjusted by an adjustment subsystem. The adjustment subsystem may provide a form for input by the real estate agent or broker or a lead, himself or herself.

Alternatively, information about the lead or preferences of the real estate agent or broker may be derived from patterns established by historical data and context. For example, a real estate agent or broker may not have time to call more than five leads during each day. An adjustment subsystem may identify the failure to call more than 5 leads in a single day as a preference or a maximum. Then, either the definition of the categories may be altered to restrict the number of leads to five for telephone calls, shifting other leads to email or mail, or excess leads may be forwarded to a different agent, broker or administrative assistant for follow-up.

In another example, the subsystem for scheduling may include an interface that allows each of the leads to enter preferences into the system. Entering preferences may adjust the scheduling of prepared telephone scripts, emails, letter, and/or combinations of these. For example, the subsystem for alerting and/or scheduling may provide an interface for adjusting definitions based on responses or tracking of leads or both Responses to contacts from the agent or the system by one or more leads assigned to one or more categories may be used to adjust scheduling, alerting and other subsystems of the system. In one example, defaults are changed over time based on historical data obtained from leads and agents. Responses may include entries by an agent regarding the outcome of a scheduled phone call, email, in person visit, letter, or other contact with a lead. Responses may also include statistics regarding an increased or decreased rate of email reading, viewing of listings, interest in listings, such as evidenced by saved listings, and requests for showings.

### BRIEF DESCRIPTION OF THE FIGURES

FIG. 1 is an example of a dashboard component in a system of real estate lead incubation that shows lead activity.

FIG. 2 depicts an example of a timeline for a buyer and seller in making a decision regarding buying or selling by conducting Internet research.

FIG. 3 shows an example of a retail e-mails sent to prospective target customers and a respective response rate.

FIG. 4 illustrates an example of a timeframe in closing on a lead.

FIG. 5 shows an example of the percentage of leads closed by dealerships.

FIG. 6 shows an example of the percentage of leads closed by a dealer and the percentage of leads not closed being closed by other dealers.

FIG. 7 depicts an example of a percentage of leads that actually culminates in a deal.

FIG. 8 shows an example of a component of a system of real estate lead incubation that shows active leads and alerts.

FIG. 9 shows an example of “lead marketing” utilized in a system of real estate lead incubation.

FIG. 10 shows an example of a header menu component of a system of real estate lead incubation.

FIG. 11 depicts an example of component providing access to a full multiple listing service listing.

FIG. 12 shows an example of a contact panel component providing access to leads.

FIG. 13 depicts an example of a contact information page component of a system.

FIG. 14 shows an example of a data entry form allowing for a user to determine predictive timeline for completing a home purchase of prospective leads.

FIG. 15 illustrates an example of a notification sent to a user, informing the user of a prospective buyer categorized in a pre-qualifying stage.

FIG. 16 shows an example of a display highlighting prospective leads.

FIG. 17 illustrates an example of a contact entry page component of a system.

FIG. 18 shows an example of importing contact information from a database, spreadsheet or CRM system.

FIG. 19 depicts an example of options for importing contact information used in a system.

FIG. 20 illustrates an example of custom field mapping.

FIG. 21 shows an example of adding and selecting groups by a user of a system.

FIG. 22 shows an example of a notification to a user when importation of data is completed.

FIG. 23 shows an example of viewing contacts in a system.

FIG. 24 depicts an example of selecting contacts to a client marketing plan.

FIG. 25 shows an example of prepackaged client marketing plans.

FIG. 26 depicts an example of series of email messages scheduled for delivery throughout the year, for a client marketing plan schedule.

FIG. 27 illustrates an example of a group of clients to be imported, by their minimum and maximum price ranges.

FIG. 28 shows an example of creating a listing alert to a targeted lead, and providing an account for the targeted lead.

FIG. 29 depicts an example of an e-mail sent to a lead who had signed up for an account in order to receive a listing alert.

FIG. 30 shows an example of a detailed view of a property search showing market statistics in a listing alert.

FIG. 31 shows another example of a detailed view of a property search showing market statistics in a listing alert.

FIG. 32 depicts an example of an e-mail sent to a buyer on a schedule chosen by the agent and/or the buyer.

FIG. 33 shows an example of a saved property search.

FIG. 34 shows an example of copying a saved property search and making such a search available to a contact.

FIG. 35 shows an example of a notification regarding sending of a saved property search to a contact.

FIG. 36 depicts an example of tracking account activity for a user registered for a listings alert account.

FIG. 37 shows an example of a detailed view of tracking a particular a user registered for a listings alert account.

FIG. 38 depicts an example of client relationship management (CRM) window, showing a contact history.

FIG. 39 shows an example of various options for various functions of a system.

FIG. 40 illustrates an example of determining in which menu items or pages may be listed on a website, for example.

FIG. 41 shows an example of a calendar and appointment function used in a system.

FIG. 42 depicts an example of pre-written letter templates for clients.

FIG. 43 illustrates an example of client marketing plans used to incubate new prospects.

FIG. 44 shows an example of a MLS quick search in a system.

FIG. 45 shows an example of a MLS power search in a system.

FIG. 46 depicts an example of selecting a boundary area for a property search.

FIG. 47 shows an example of a results for a property search.

FIG. 48 depicts an example of viewing a selected property detail.

FIG. 49 illustrates an example of contact panels for a group of contacts.

FIG. 50 shows an example of window displaying e-mails.

FIG. 51 depicts an example of a customized and saved report for a lead.

### DETAILED DESCRIPTION

The examples described and the drawings rendered are illustrative and are not to be read as limiting the scope of the invention as it is defined by the appended claims. An example of a system for incubating leads directs communications, saves information about leads and provides information to an agent/broker about leads. For example, the system works with an underlying client management system and website to capture information about emails read by a lead and the type, number, and frequency of certain activities indicative of a leads interest. In one example, the system is used in a real estate practice, such as a real estate practice focusing on the buyer side requiring long lead incubation times. A personal website is provided to a lead that tracks and records viewing of listings and other activities of the lead in order to provide personalized and timely service by the agent/broker or an assistant to the agent/broker. Access to a personalized and uniquely identified website or database allows the lead to exercise control over features provided to the lead. Preferences of the lead or selections of listings by the lead, notes made by the lead and/or access to other tools or information on the website in the database offers the system insight into the lead's current interest and readiness to buy real estate, for example.

In one example, a database is populated with prospects or leads, which may be generated from an internet form or otherwise. Mailings may be generated for listings on a periodic basis, such as daily, weekly or monthly. The lead may select the frequency of mailings, for example. The system may provide the lead with an active IDX listings search or other means of searching real estate listings such as RETS with easy to use searching functions. Information may be presented to a lead, such as maps, pictures or other information. For example, the system allow customization of an active “drip mail” function by the lead or under control of the agent.

In one example, the system tracks and reports any all responses by a lead to emails, listings, mailings and the like. For example, the lead may be presented with a customized website that tracks the activities of the lead. The system may suggest or may automatically adjust an interactive, customized website based on lead input. The system may inform or flag certain activity of the lead for the agent, especially if the activity indicates that a follow-up or direct interaction is needed between the lead and the agent. An email and the website may be integrated with click tracking mechanisms, such as single pixel gif images or hidden pixel links, email receipt notices, email read notices, and the like.

It is believed, without being limiting in any way, that buyers in the initial research phase are not looking for a transaction with a live real estate agent (or broker). Buyers may be reluctant to divulge personal information, for example. On average, buyers contact between two and five realtors. The system permits an agent to be first to respond and to respond in the way that the buyer chooses. The system builds a non-threatening relationship between a potential buyer and a real estate agent, over days, weeks, months or years, without unduly burdening the agent or broker.

For example, three phases may be identified in a buyer's process of finding a new home. The first is a research process: locating neighborhoods of interest, pricing homes in those neighborhoods, and determining an agent knowledgeable in those neighborhoods of interest. The second phase includes more specific research, which may require additional interaction with a real estate agent, relating to lifestyle issues, how much home can we afford, what is the state of the market, where are the best deals, and the like. Finally, in the last phase, a buyer is ready to start looking at homes (either drive by or, eventually, with a realtor). At some points in this cycle, a buyer may need to speak with a real estate agent; however, one example of a system provides many of the answers that would usually require a live real estate agent, and the system may custom configure a website for the buyer based on a predictive pattern that determines when the buyer will be seeking such information.

In one example, the system separates the merely curious from actual prospective buyers without any substantial effort by a real estate agent. The system incubates actual leads during the initial stages of the cycle. While the entire cycle may last eighteen months or more, the system is capable of providing reports that quickly discern the 50% of leads that are actual prospective buyers from the 50% who are merely curious. The merely curious will not enter the second stage of the cycle and will not have the same pattern of usage as the 50% who are actual prospective buyers.

For example, the system is capable of reporting when a prospective buyer enters the second phase and probably needs some help in narrowing the listing to those neighborhoods and homes within the buyers means and meeting the buyers needs. It allows the system or the real estate agent to seek or adduce additional information about the buyer, such as size of family, income range, outstanding debts and time horizon for buying a home. Furthermore, the system is capable of showing that the real estate agent is knowledgeable about the neighborhoods of interest or may refer the buyer to another real estate agent more familiar with the neighborhoods of interest. This may include an introductory letter and/or porting of gathered information from the system of one real estate agent to the system of another real estate agent.

In one example, the information is gathered without any hard sale or any sales pitch. The system (and the agent) may appear merely helpful and non-threatening. In one example, the system may be used to educate the buyer about the difference between a real estate agent and a buyer's agent. A buyer's agent will want to distinguish the agents website from other real estate agent's websites, who are representing the interests of sellers and not buyers. The website of a buyer's agent has the advantage of establishing a trustful relationship between the buyer and the buyer's agent, which a seller's agent cannot match.

In one example, the system alerts an agent when the buyer is likely to be entering the third phase. In this phase, the agent may be encouraged to make direct contact with the buyer to “show” the buyer homes in areas of interest, within the buyer's price range and that meet the buyer's needs. The data in the system may be used by the agent to select a tour of homes, or the system may select such homes for the agent with input from the buyer.

In one example, the system facilitates the agent, and through the agent the buyer, in negotiating a purchase of a home. The system provides information about homes of interest and comps in the area. It may provide information on mortgage brokers, who may be recommended by the real estate broker/agent. While the lead may be dealing with more than one agent in this third phase, the system may provide an advantage in responsiveness and anticipation of a buyer's needs.

The system allows the broker/agent to reply within 24 hours to any request by a lead. In some cases, an immediate response is prepared and may be released by the broker/agent. One advantage of the system is that the system may deduce a prospects desired response time, attention cycle, and needs, based on a past pattern of behavior tracked by the system. In one example, the system flags the broker/agent, allowing the broker/agent to be standing by, yet immediately available, when the lead has a question or wants to see houses.

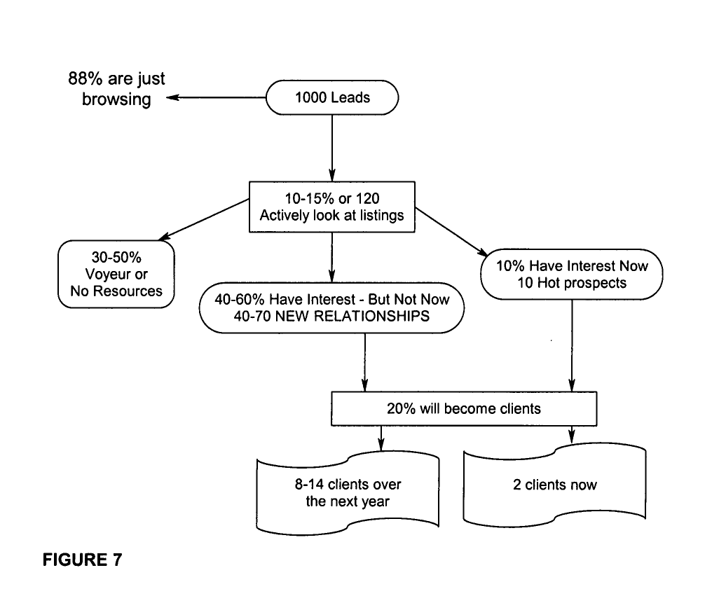

Without being limiting, it is believed that the system will allow a broker/agent to capture about 20% of actual prospective leads as buyers of homes using the services of the broker/agent, which is about 10-16 leads per one thousand leads filling out a form on a real estate website, as shown in FIG. 7. In contrast, the common wisdom of picking the “low hanging fruit” would only capture about 2 leads per thousand, which are the ones that happen to be ready to purchase a home now. The system discriminates those leads who are merely browsers, which is shown to be about 88% in FIG. 7. Capturing an additional 8-14 leads using the system, compared to only 2 using the traditional philosophy, is very surprising and unexpected for a person of ordinary skill in the field of real estate sales. The system may be used for other high value property sales that have long sales cycles and include buyer/seller agents, such as luxury yacht sales, boat slip sales, private airplane sales, and the like. Although not real estate, necessarily, these types of sales share many similarities for the agents and buyers.

The system provides a virtual assistant, available to a buyer 24 hours each day.

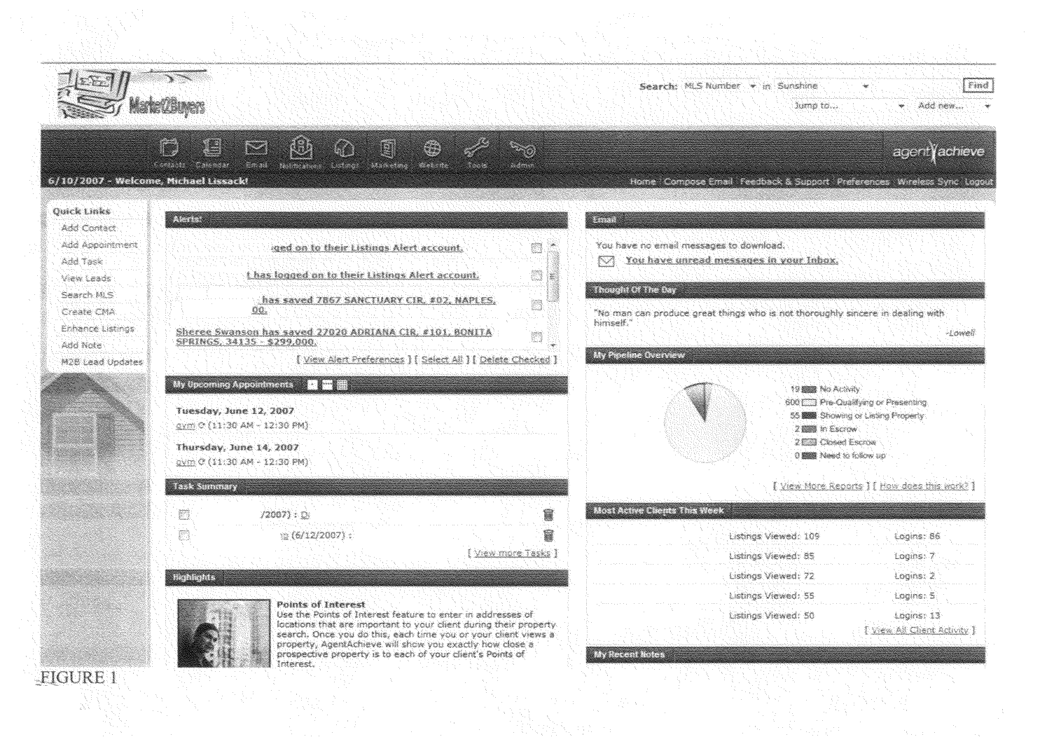

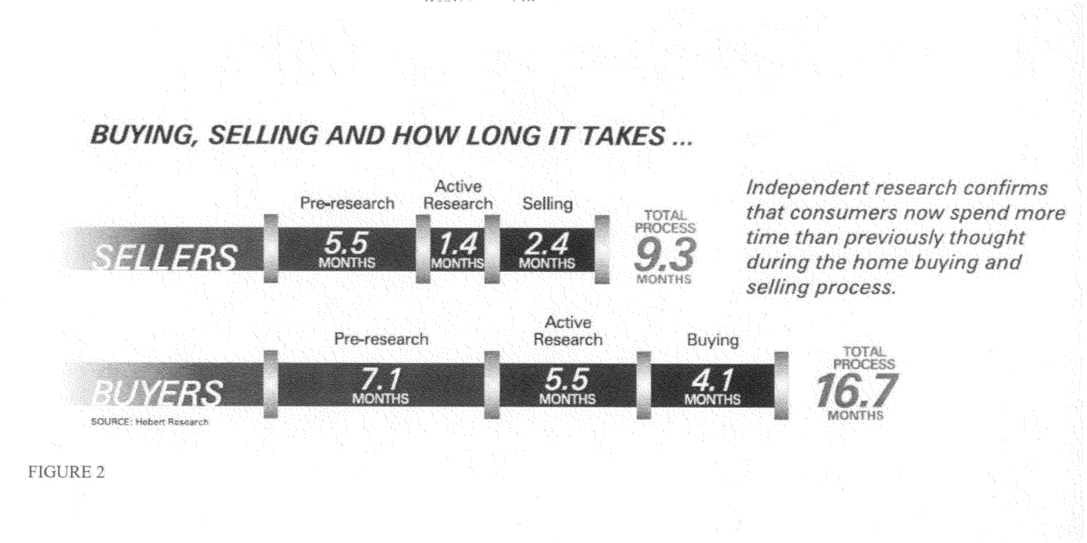

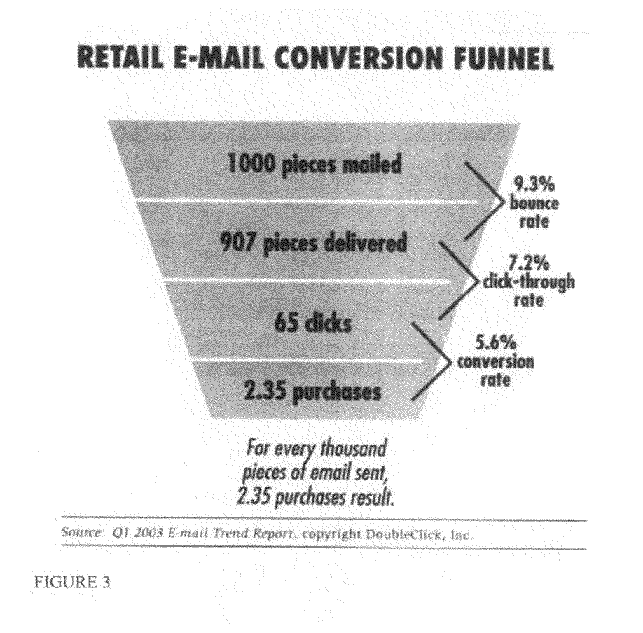

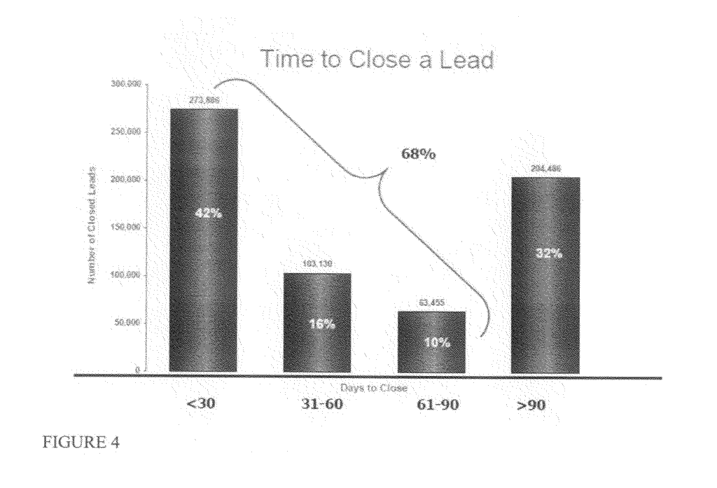

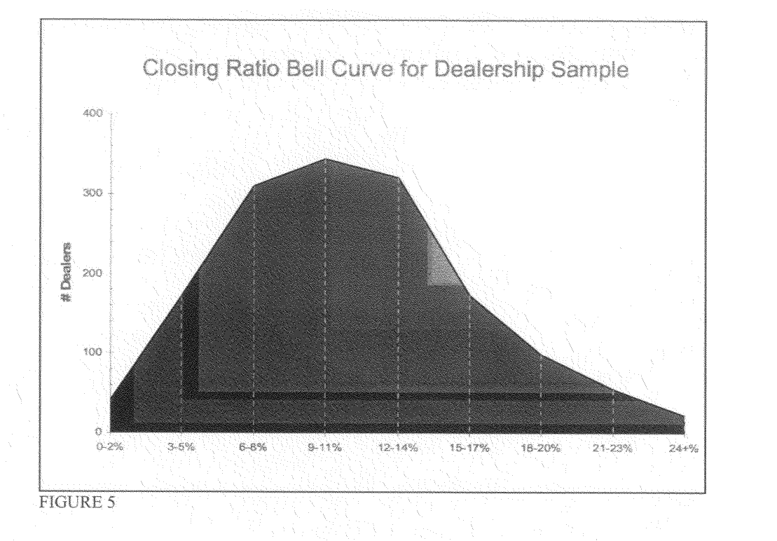

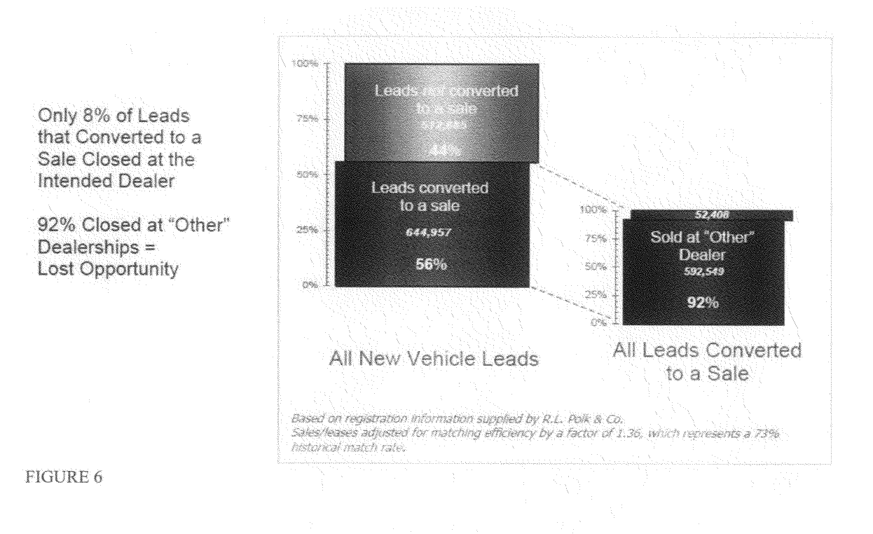

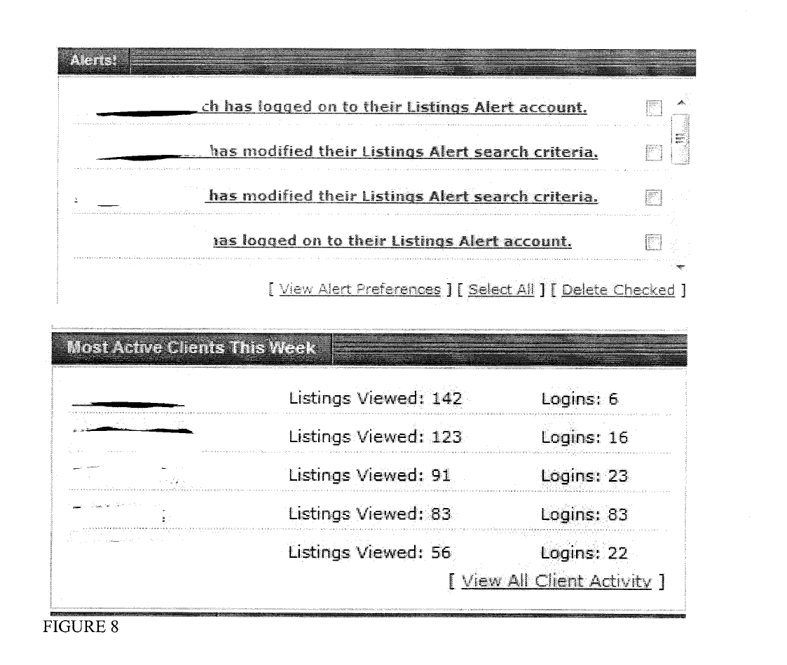

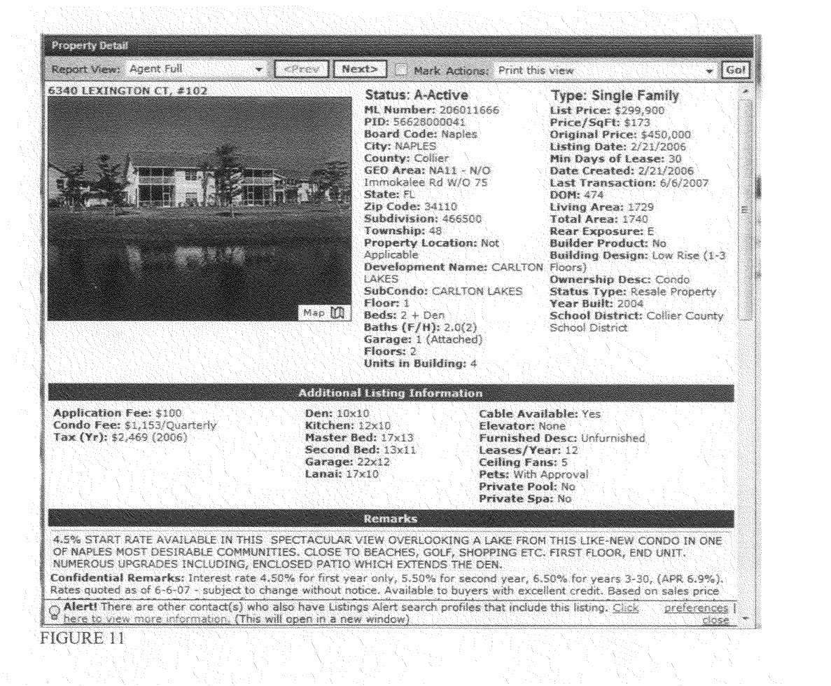

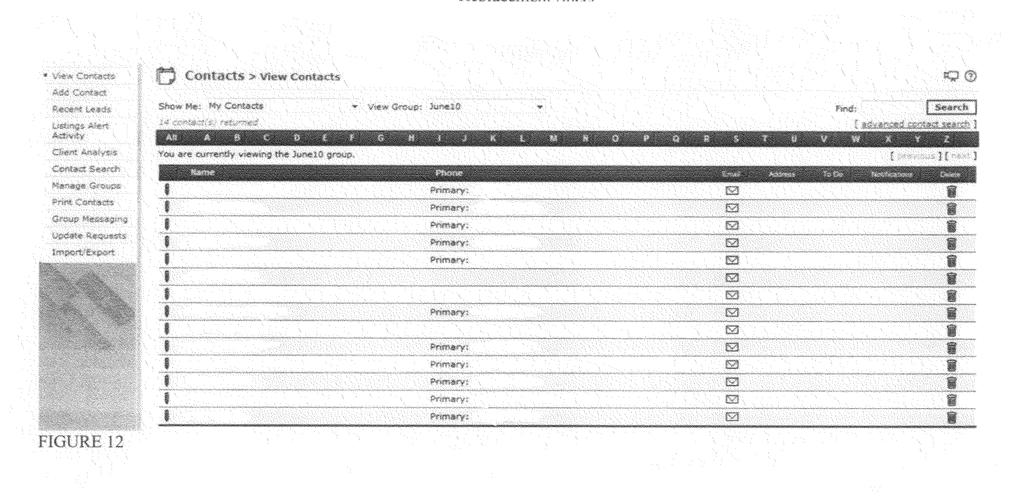

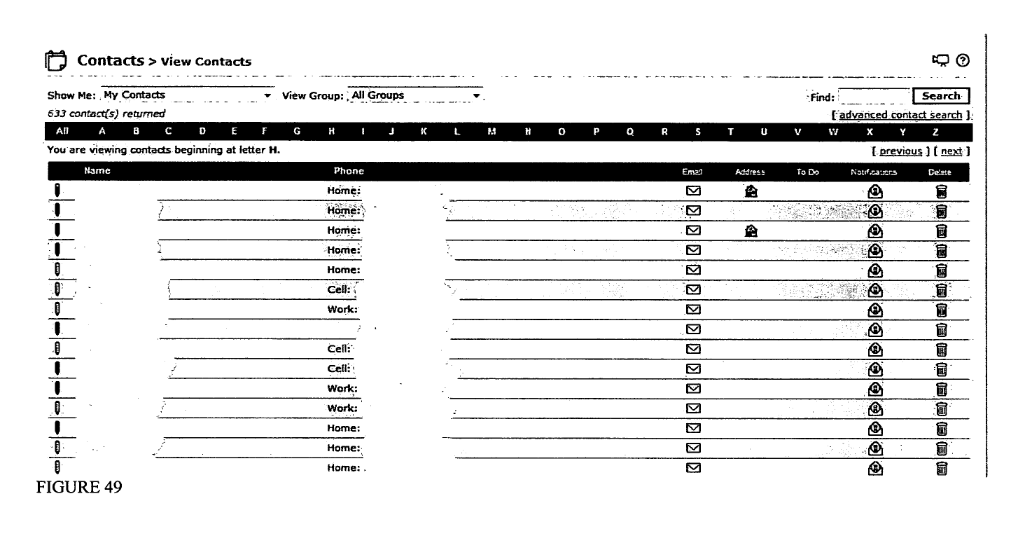

The system provides an agent with a dashboard, such as shown in FIG. 1, that shows lead activity, such as in an alert section, any new activity within a customizable period, such as activity during the past 24 hours, and a listing of the most active leads, for example, as shown in FIG. 8. A header menu may provide access to many useful functions, such as shown in FIG. 10. For example, the dashboard may provide access to the full multiple listing service (MLS) used by the broker/agent, such as shown in FIG. 11, and access to leads through a contact panel, such as shown in FIG. 12. Searching tools provided by the system may be customized and may allow customized displays of results, for example. Contact panels may be shown starting at any letter or for any group of contacts, such as the example shown in FIG. 49.

In one example, the dashboard provides customized guidance for the next actions to take, at the appropriate time, with each and every lead entered into the system. The list of actions to take is developed based on patterns or triggers, established by default or customizable by the agent, of activity by leads using the system. For example, heuristic algorithms are used to alert the agent when to call or otherwise contact certain leads by email or mail. In one example, scripts are included for telephone calls to be made by the agent. In another example, a letter is provided. In yet another example, an email is provided. The action taken may depend on the classification of a lead to a class. For example, leads residing locally may be a different class than leads residing elsewhere and looking to relocate to the area.

One example of a heuristic algorithm is the following:

| | distance | last login | viewed listing | saved listing | last contact | emails viewed |
|---|---|---|---|---|---|---|
| action suggested | (miles) | (days) | (per day) | (per day) | (hours) | (ratio) |
| Make anappointment bytelephone | <50 | <4 (days) | $\geq \frac{1}{3}$ | $\geq \frac{1}{3}$ | $> 24$ | $\geq \frac{2}{3}$ |
| Offer moreinformation ormake an appointmentby telephone | | <4 | $\geq \frac{1}{3}$ | $\geq \frac{1}{3}$ | >24 | $< \frac{2}{3}$ |
| Suggest next stepin search by email | | >3 | $< \frac{1}{3}$ | <1/3 | >48 | ≧5/7 |
| | | <8 | ≧1/7 | ≧1/7 | | |
| Contact for more | | >15 | <1/7 | >1/7 | >120 | <2/7 |
| information about | | <31 | ≧1/30 | >1/30 | | |
| need and to verify | | | | | | |
| email address by | | | | | | |
| telephone and mail | | | | | | |

For example, leads may be classified as hot, cold or warm. In one example, the system suggests a call within 24 hours for any hot leads, email or call within 24 hours for any warm leads, and an email or call within 72 hours for cold leads. A warm lead may be defined as a lead who has looked at emails more than 3 times during the past week, has saved one or more properties as being of interest during the past week, and has not spoken to or visited with the agent during the past week for example. A warm lead may be contacted by email (or telephone) within 24 hours.

A hot lead may be defined as a lead who has saved 3 or more properties during the past three days, has logged into their web account three or more times during the past three days, and is local. In this case, the assigned agent should check, by telephone, if the lead wants to schedule an appointment to see some homes, such as those saved by the lead. For example, the table below shows some heuristic algorithms for classifying whether a lead is hot, warm or cold with respect to follow-up. Ratios are determined based on the integer number of events divided by the number of days or hours in a period. This “frequency” is then converted to an integer, such as by rounding, and the heuristic algorithm is applied.

Results may be output as a list of contacts to contact. The system may prioritize contact and may suggest a time period for making contact with a lead. In one example, automatic messages are generated to establish or reestablish contact with a lead.

Table 1 shows one example of a set of heuristic algorithms for establishing contact with certain leads based on information tracked and recorded by the system. This may be tailored by the agent/broker, by data mining to determine patterns associated with successful outcomes, and/or as preferred by the lead, himself or herself. Information such as distance of the lead from the location of the realtor, days since the last login using a unique userid, the frequency of viewed listings, the frequency of listings saved, the time elapsed since the last contact with the agency or broker, and the ratio of viewed emails to unviewed emails, together with lead preferences established by the system, agent or the lead, himself or herself, may be used to determine when an agent should call, email or mail a lead and for what reason. An automated script, email or letter may be generated by the system that may be customizable by the agent/broker. The time period for delivering rates or frequencies may be determined from defaults in the system, which may be periodically updated, or may be selected or customized by an agent or broker or both thereof, for example. Thus, a rate based on per day might be changed to per hour or per week or per month.

The system may classify a lead according to price range and area of interest. The buyer or the agent may set up one or more drip email campaigns and/or one or more sets of automated listing alerts, such as the alerts shown in FIG. 7. The price range, area of interest, drip email campaign and automated listing alerts may be changed by the system over time based on lead activity in the system.

The triggers and patterns may be reconfigured by the system based on the interaction of the lead with the system. For example, successful sales may be used to establish patterns and triggers within the system, which may dynamically adjust the heuristic algorithms for one or more class of leads.

A lead may be identified by a login identifier that is used to access a customized web portal used by the lead. In one example, the lead may be allowed to add favorite links to a customizable web portal both accessible and customizable by the lead. All of the activity of the lead may be tracked and reported to the agent.

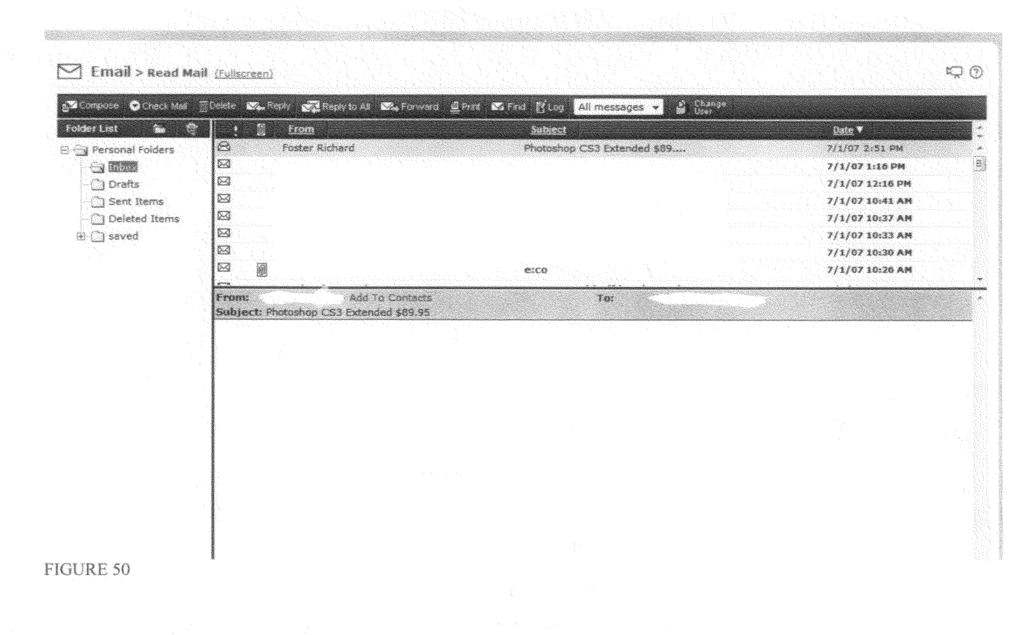

The system then monitors and reports on activity of the leads. Emails may be displayed in a window, such as the window of FIG. 50, from any email account, such as a blackberry, POP3 or corporate email account. These emails may be completely integrated with the system and may include facsimile transmissions and short message service messages. The system may integrate all communications to and from the agent/broker, such as telephone, email, facsimile, voicemail, short message service, pager messages, cellphone and others.

The system allows an agent to organize and group leads, such as by the price range of homes that the lead is interested in purchasing and/or area of interest and/or neighborhood and/or zip code and/or home size and/or any other criteria selected by the agent.

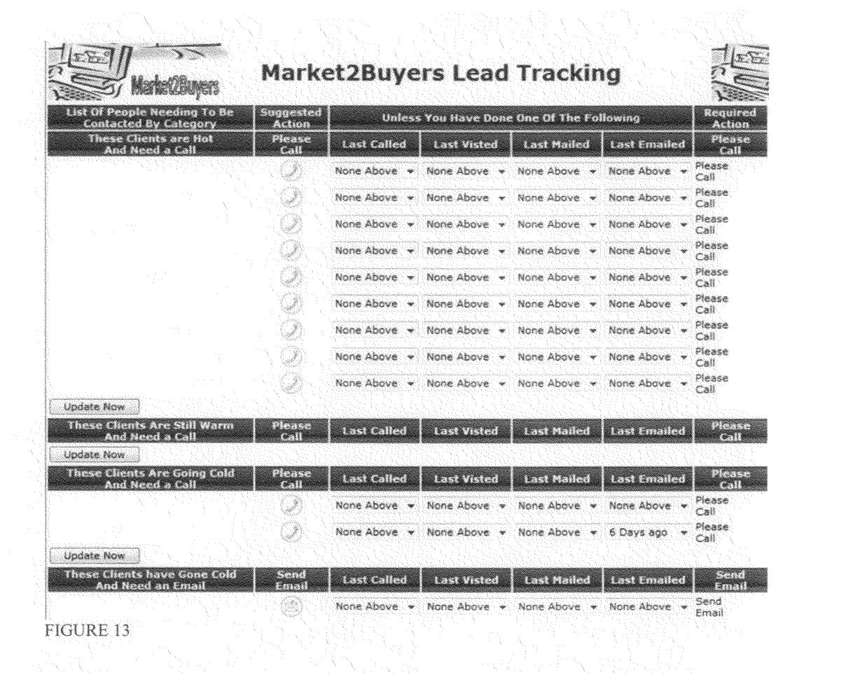

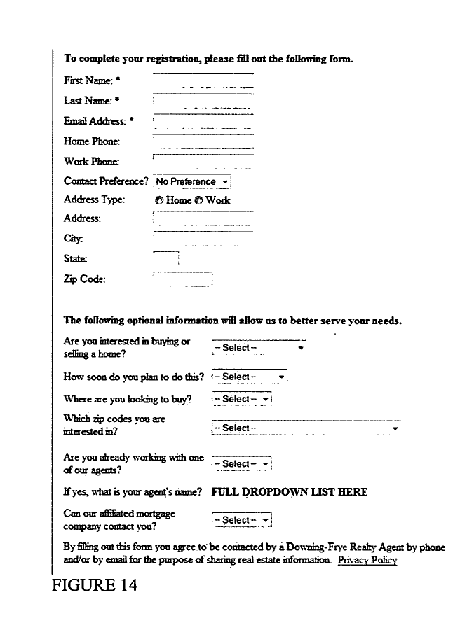

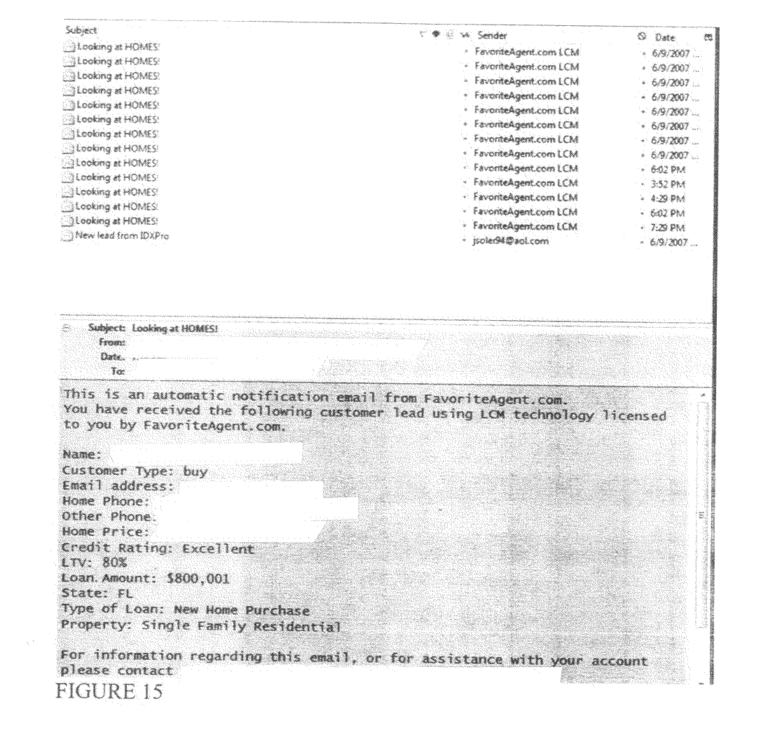

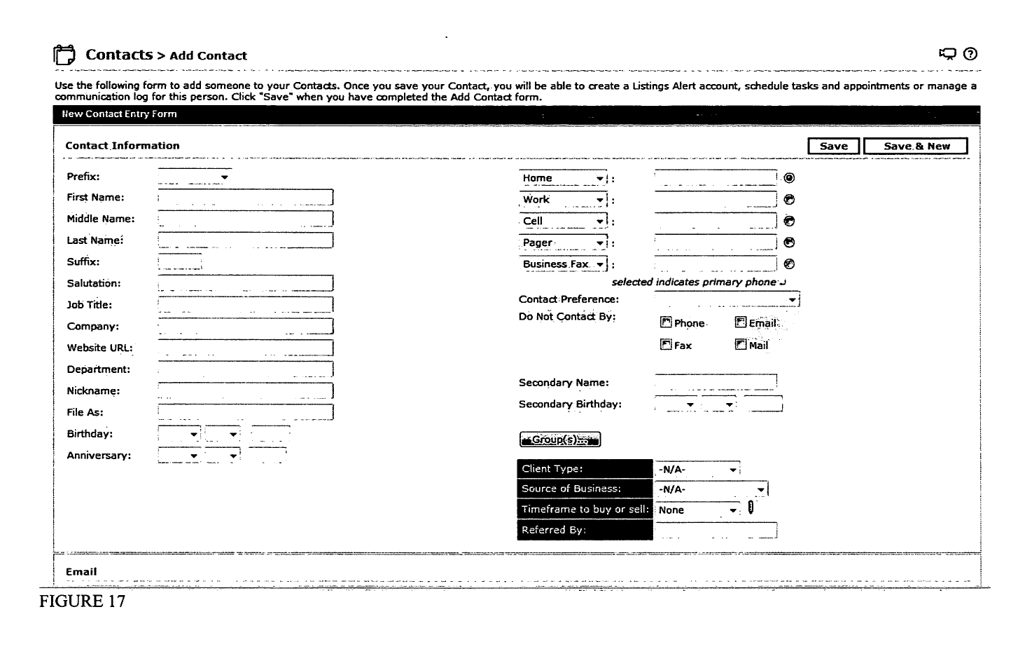

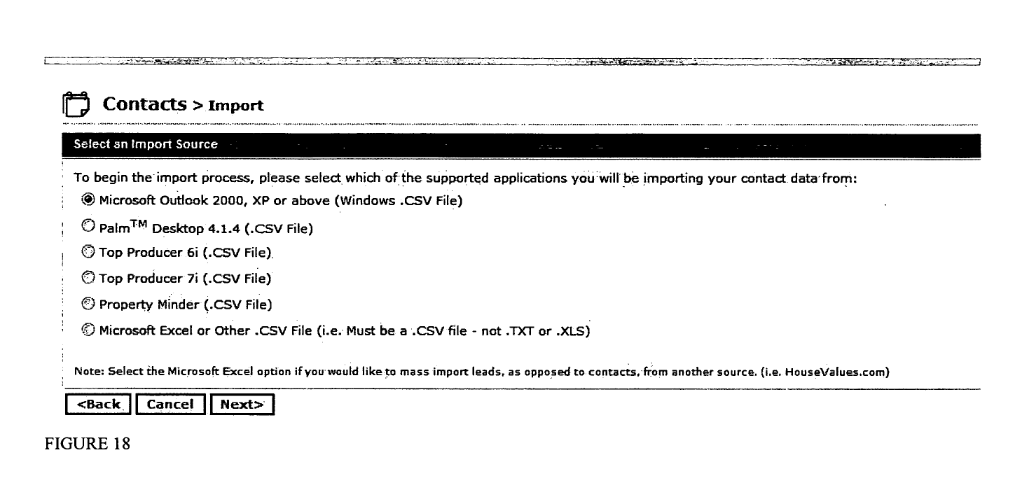

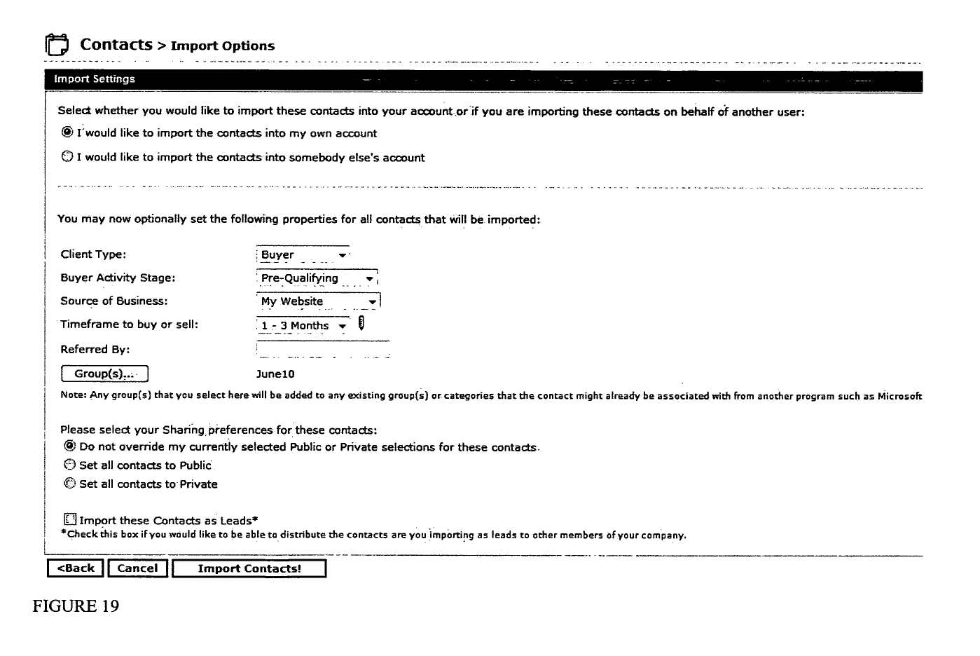

FIG. 13 illustrates a contact information page of a system. For example, an agent may type directly into a contact entry page, such as shown in FIG. 17, information may be imported, such as shown in FIG. 18, from a database, spreadsheet or CRM system. For example, information may be imported from Outlook, Palm Desktop, Top Producer, PropertyMinder, a CSV file, ACT!, HouseValues, HouseHunt, realestate.com, and the like. The CRM in the system may provide all the functions of a standard CRM, as well as the functions described herein, such as an opportunity to label, categorize, and group the lead. For example, the drawing in FIG. 13 illustrates leads classified in several groups. In another example, a buyer may be grouped in a pre-qualifying stage and/or by the location from which the lead came, such as via a website. A notification may be sent to an agent, such as the notification in FIG. 15, when a lead is initiated in the system or when some other activity occurs. In one example, this message is sent to a handheld device, a cellphone and/or a pager. The system may show a predictive timeline for completing a home purchase of prospective leads, such as less than one month, one to three months or longer than three months, which may be initially entered in a data entry form, such as shown in FIG. 14, or may be determined from actions of the lead tracked by the system on the leads personalized website. This predictive timeline may be updated from time to time, for example. Alternatively, this information may be input initially by an agent during data input or importing, such as shown in FIG. 18. In the example, the agent/broker is able to select whether the new lead(s) is entered into the agent/brokers account or another's account, such as an assistant's account to which the importer has access.

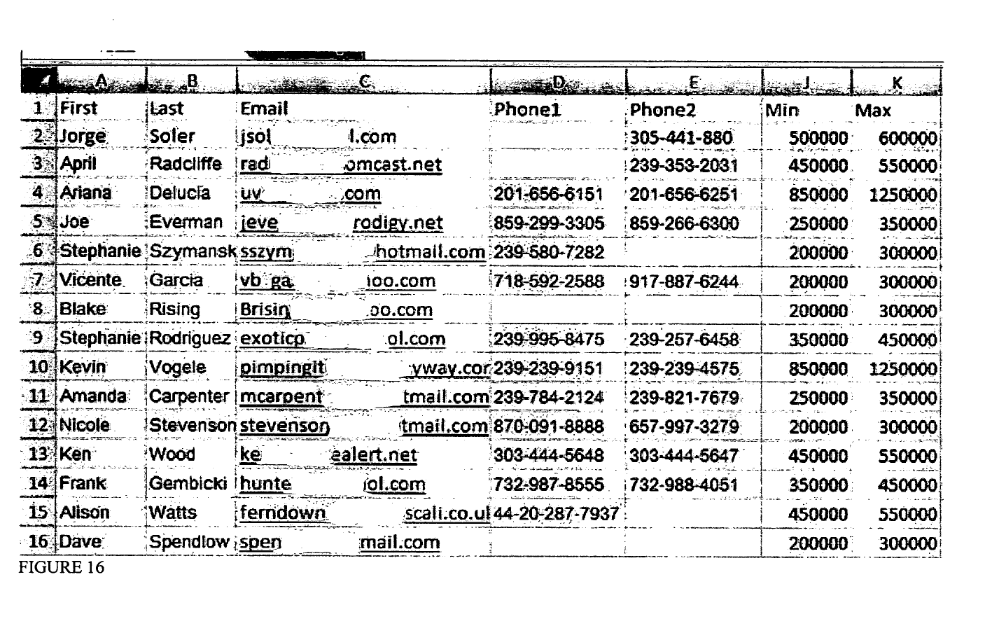

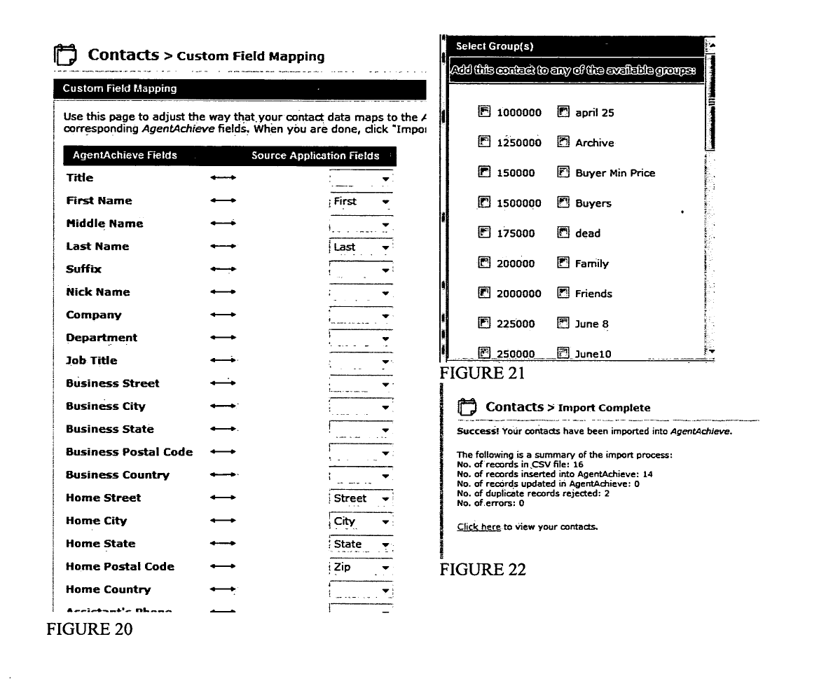

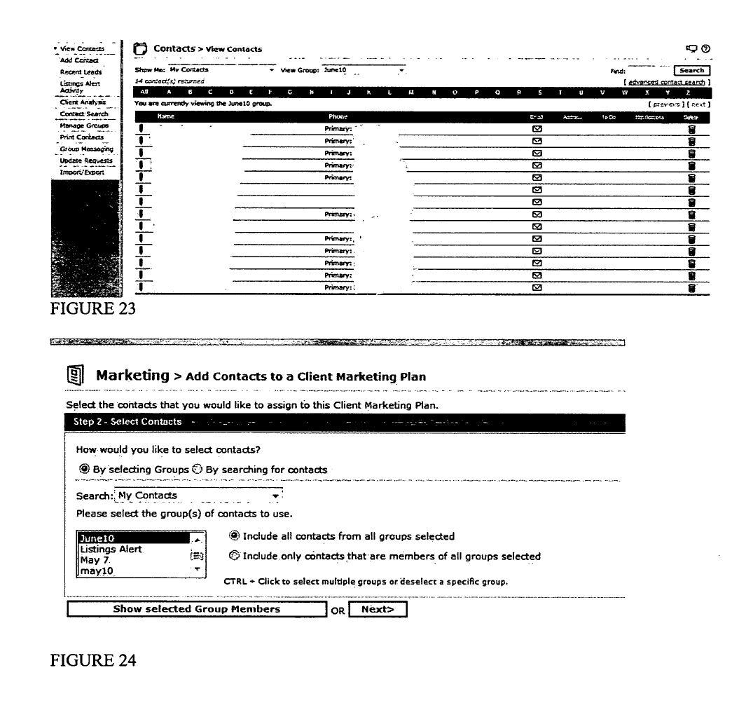

When importing data, the system may allow an agent to map fields, such that data entered into the system is correctly matched to the system's database fields, as shown in FIG. 20, for example. For example, the system may allow an agent to add and select groups, such as shown in FIG. 21, and to report back when importation of data is completed, such as shown in FIG. 22. Contact data fields and displays may be customizable, such as the fields shown in FIGS. 16 and 23, for example.

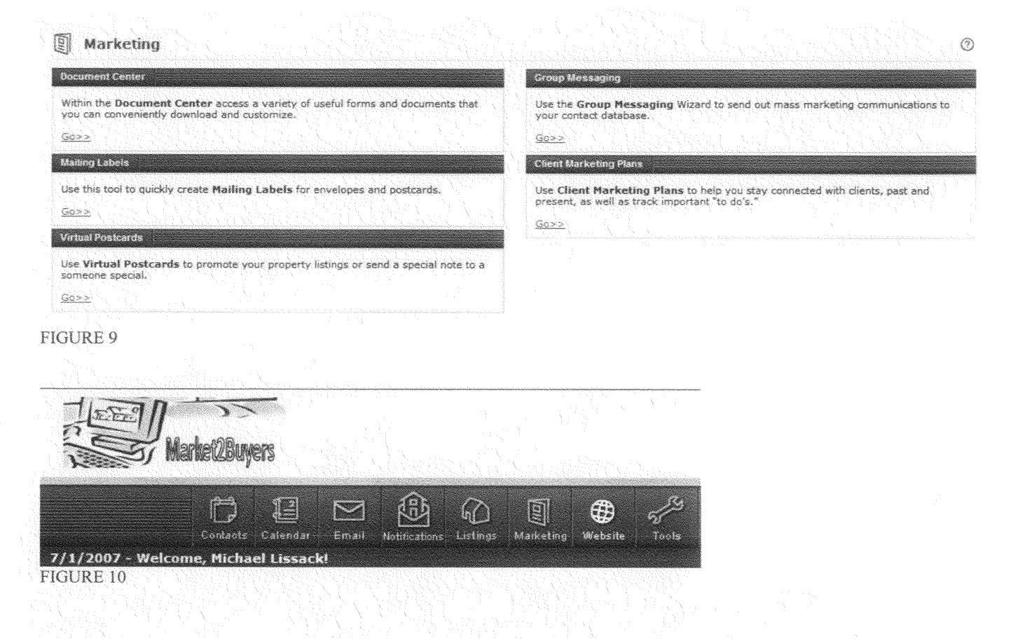

An initial broadcast may send a message from the system to all newly added leads or periodically to all leads or any subset of leads. These may be referred to as a “client marketing campaign,” plan, or lead marketing, such as those shown in FIG. 9, for example. These may be established for individual leads or groups of leads according to the agents (or the leads) preferences, such as shown in FIG. 24. In one example, a lead may be given the option to opt out of one or more client marketing campaigns.

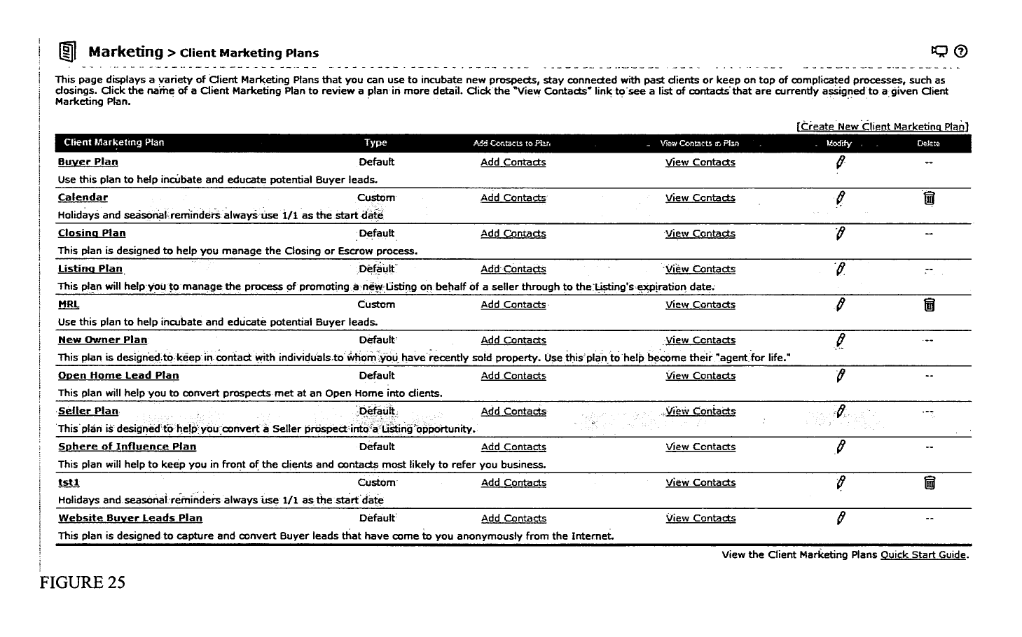

Some examples of prepackaged campaigns include the examples shown in FIG. 25, for example. For example, a calendar campaign may send contacts periodic emails based upon holidays or times of the year, such as Spring cleanup tips or July 4^{th} greetings. A buyer campaign may send periodic messages about the buying process, which may be tailored to the class of buyer, such as a resident buyer or a buyer moving to the area from a distant location. The former may be interested in different information than the latter, who will likely need much more information on the cultural, demographic, transportation, and lifestyle features of the local area. Both may be interested in local engineering inspection and mortgage broker/bank referrals, housing price trends, newly developing neighborhoods and featured neighborhoods, for example.

A lead follow-up campaign may send periodic messages asking for reactions to sent listings feedback on services and information provided, updates on timelines, and the like. More than one campaign may be active per lead at any particular time. Furthermore, campaigns may be tied to activities of the lead that are captured by the system. Triggers and patterns of heuristic algorithms may be used to start, end or extend campaigns for particular leads, for example. For example, one trigger may be when the first appointment for viewing of real estate is scheduled. Another trigger may be when a contract is signed. Yet another trigger may be the day that the lead closes on a home. These dates are entered into the system and may be used to start, stop or extend campaigns, for example.

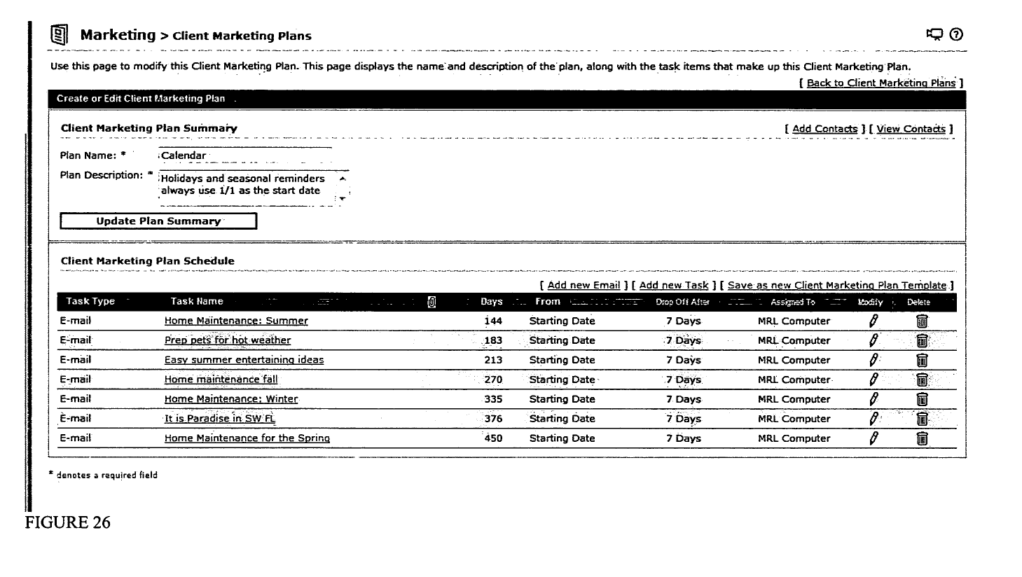

The system allows an agent to create a custom drip email campaign, for example. In FIG. 26, a series of email messages are scheduled for delivery throughout the year, with reminders for activities for leads, which may be seasonal, for example.

In another lead marketing service, a series of periodic, such as daily or weekly, listing updates alert a lead to activity in the lead's market of interest, which may include new listings, changed prices to listings of interest, crime reports, school reports, events, social activities, open houses and the like.

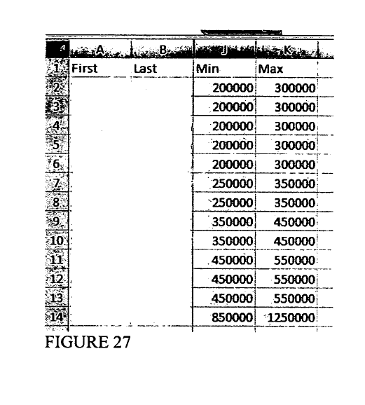

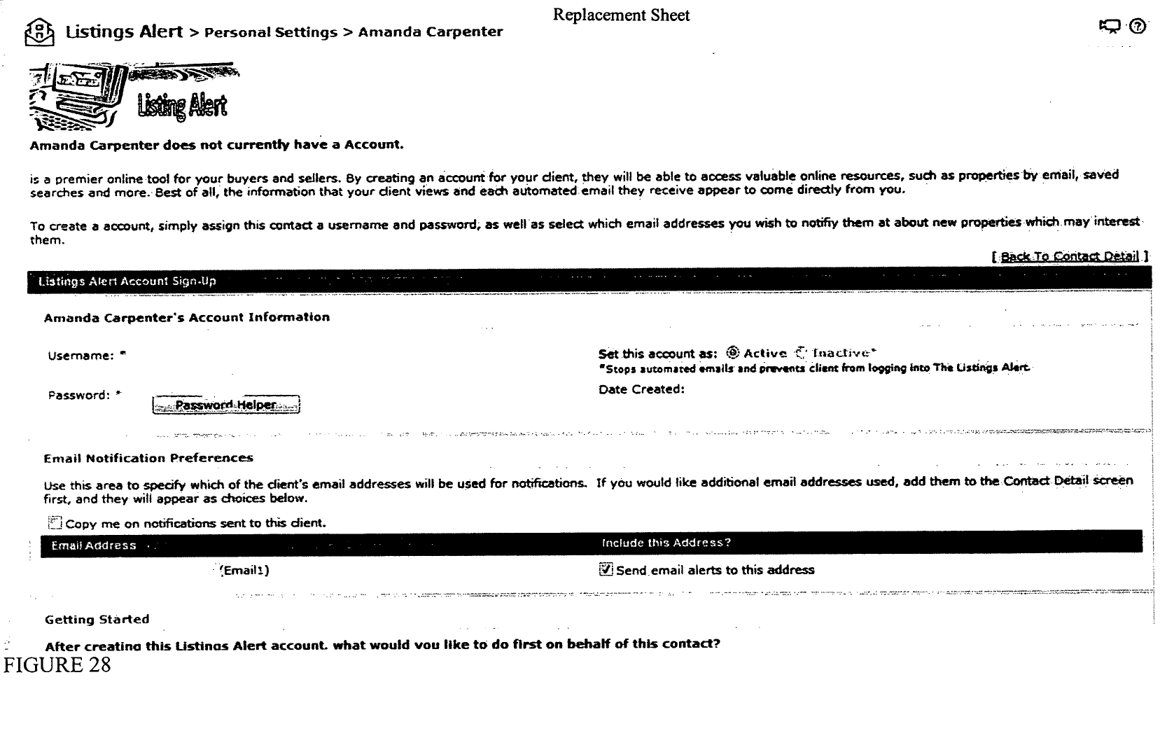

FIG. 27 illustrates an example of a group of clients to be imported, by their minimum and maximum price ranges. The system creates a listing alert by providing each lead an individual account. The lead receives a username and a password, such as shown in FIG. 28. Alternatively, the leads may be tracked with cookies. An individual account allows listing alerts to go out to each lead by email, and gives each lead access to a personally customized website, set up just for them by the agent and/or with their interactive input.

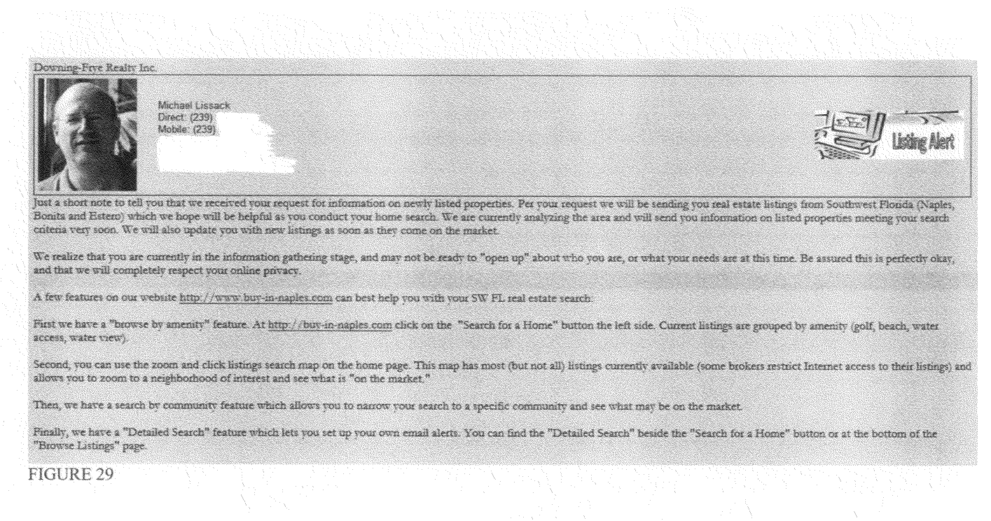

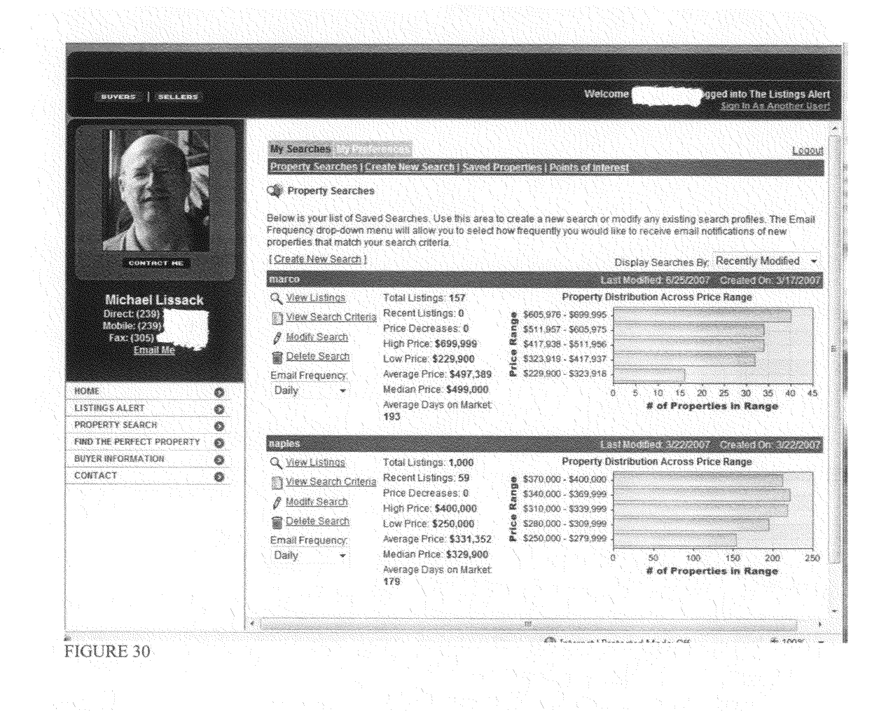

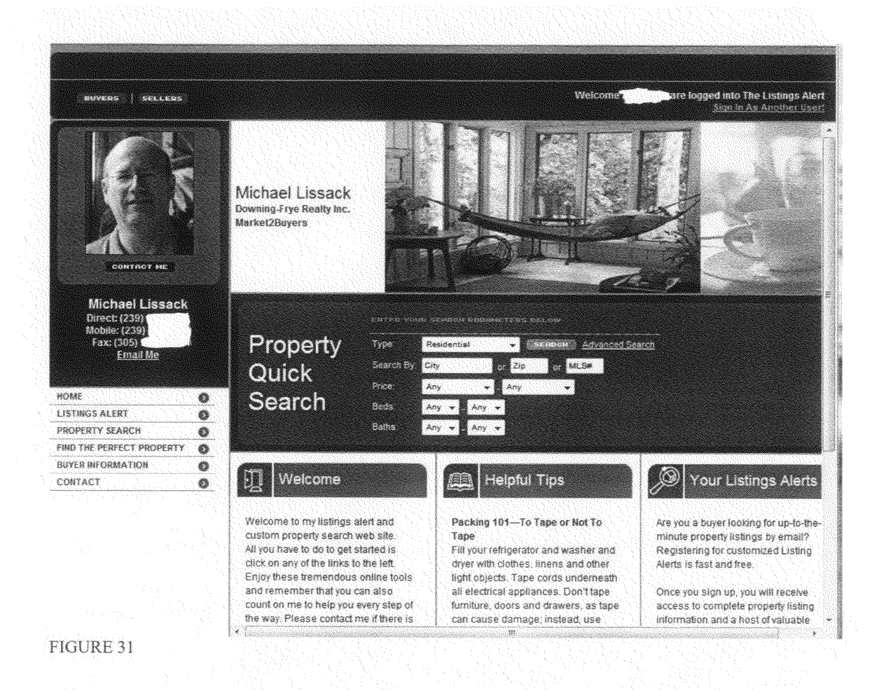

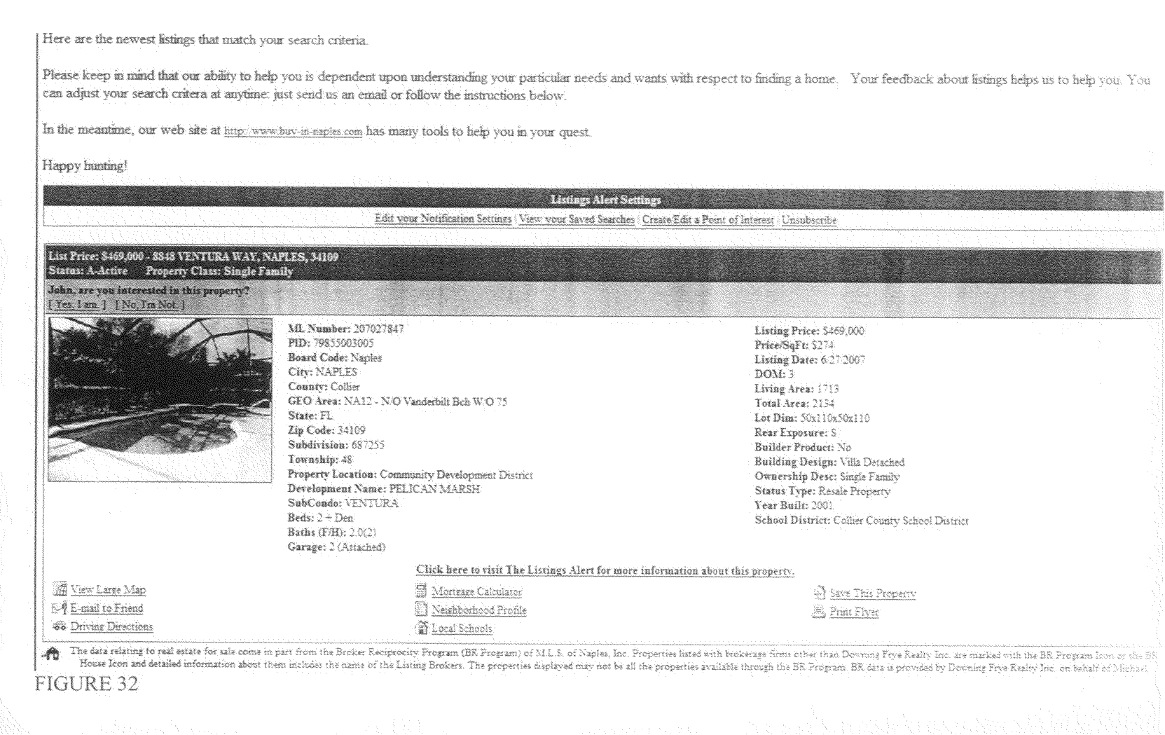

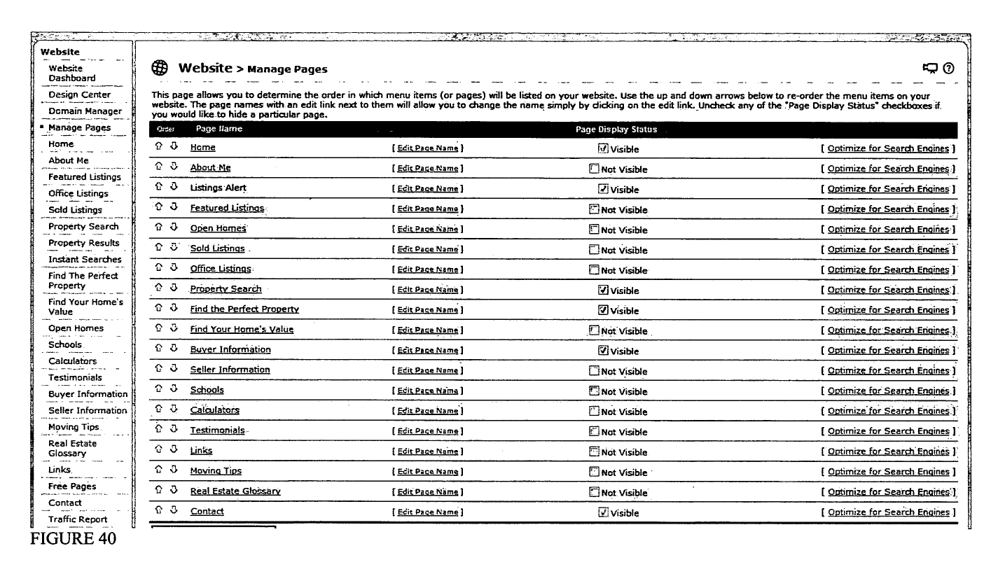

Once a listing alert account is created on the system, the system may automatically send an email to the lead, introducing the system's services, such as shown in FIG. 29, for example. A welcome message may provide login information or a customized link for the lead to use to access a personalized website, such as shown in FIGS. 30 and 31. For example, a listing alert login identifier and/or password provides access for a prospective buyer to a website customized (and further customizable) for that particular buyer, such as by a customization window shown in FIG. 40, for example. Whenever the buyer accesses their own personalized website, the system is capable of tracking and storing all activity of the buyer, such as searches, saving properties, storing information, making notes, determining cost of a mortgage, prequalification for loans and other actions. The system may deduce, over time, a significant amount of information about the buyer's preferences, price range, needs and desires, which may all be used to assist the buyer in selecting suitable homes for viewing during a purchase phase.

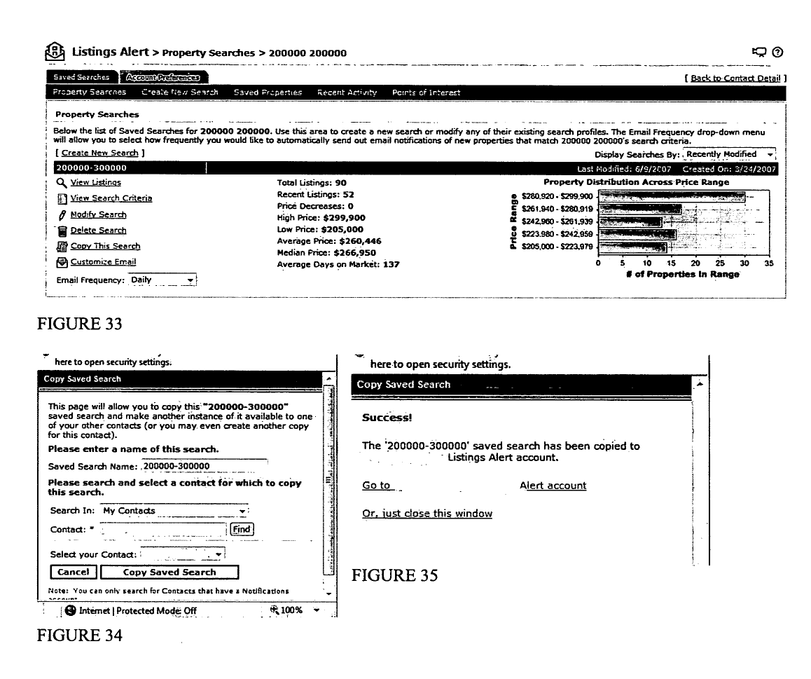

In one example, listing alerts send updated listing information to the a buyer by email, on a schedule that is chosen by the agent and/or the buyer, such as the email shown in FIG. 32. The system allows the buyer to create new searches and to change criteria by following the links provided in FIGS. 32 and 33, for example. The new search criteria may be saved, as shown in FIGS. 34 and 35, for example.

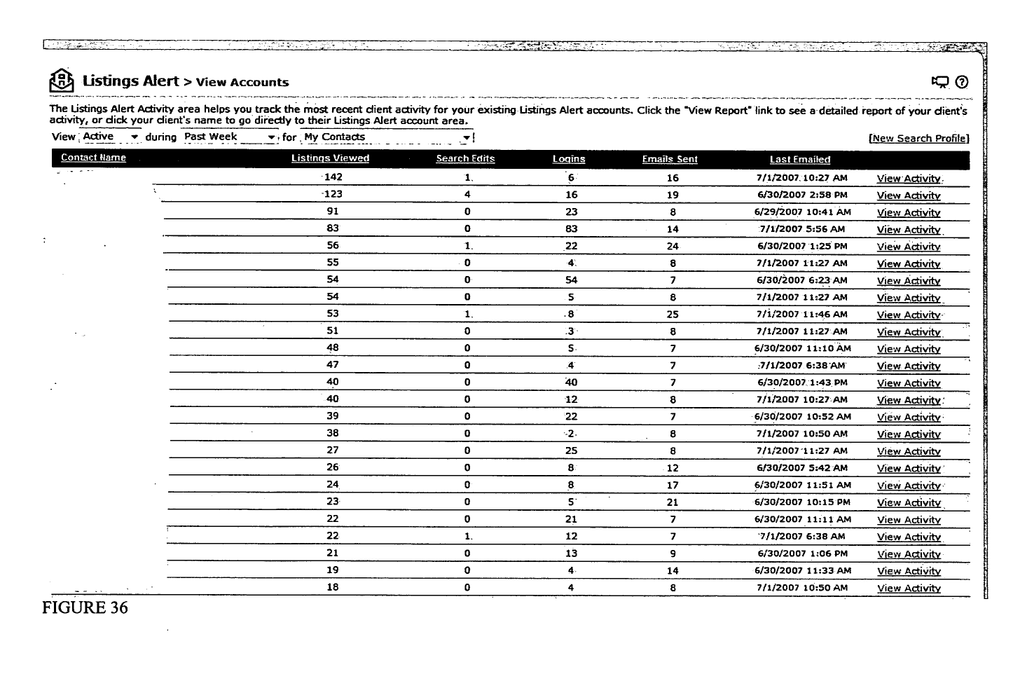

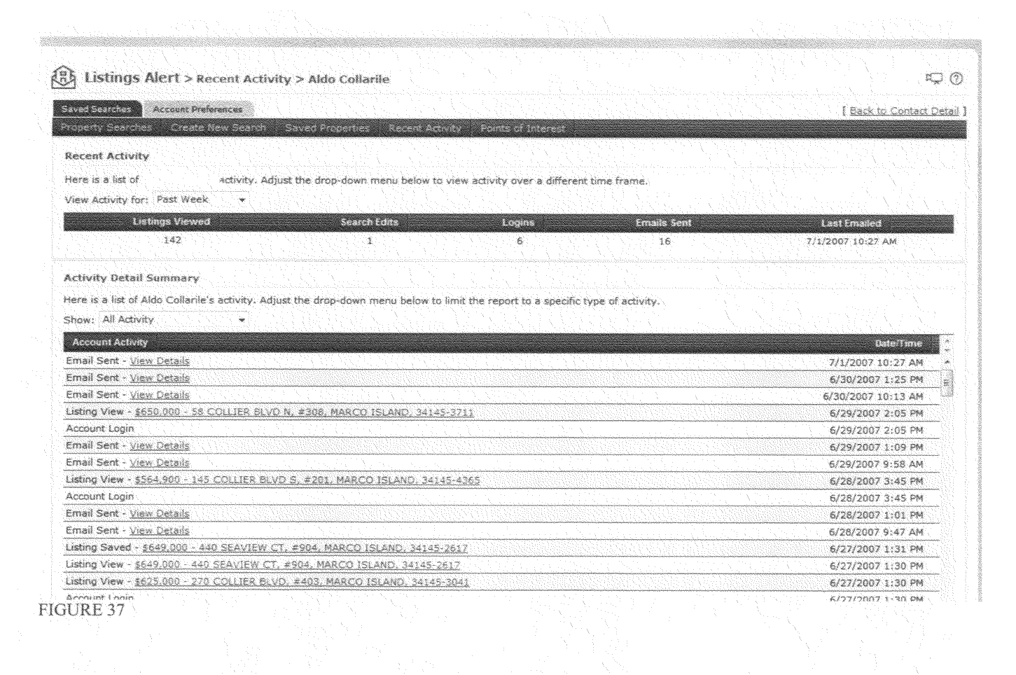

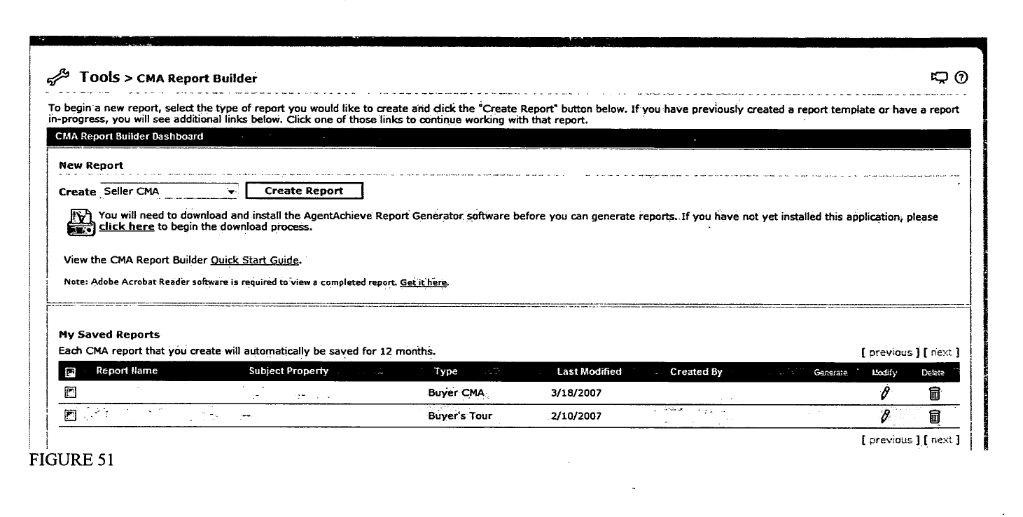

The agent may be allowed to view and receive reports and alerts on any and/or all activity on the personalized website, such as shown in the listing of FIG. 36. The system knows when and if emails are being read, if the client is logged on, what the client is doing when looking at listings or looking at the customized client website. The agent may be able to drill down and see as much information as desired about client activities, such as in the report shown in FIG. 37, for example. This information is invaluable to the agent and allows the system to schedule alerts to the agent for follow-up with the client, for example. Reports may be customizable and may be saved, such as shown in FIG. 51.

For example, when a lead requests to view a home, then the system alerts an agent to follow-up with the lead within 24 hours and includes a list of other homes similar to the specific home requested. Information is provided on the specific home, such as whether it is under contract or not.

Additional triggers may be identified based on experience of the system or the agent, and the agent may customize the system for alerts by adding triggers or changing or deleting some triggers. For example, a contact who has saved listings for viewing in the past but has not looked at emails for more than 30 days may need to be phoned or contacted by regular mail. A contact who goes from looking at their web account once a week to several times a day may need an immediate telephone call. A contact who is saving homes from multiple areas or multiple price ranges may need to be contacted to have separate search accounts created. This might indicate usage by more than one person, for example.

While many examples of patterns and triggers have been identified, it should be understood that these may be dynamically reconfigured by an agent, by the system itself based on “experience” in the local market using the rules of expert systems and measures of success, and based on input by a buyer or seller. Changes in the patterns and triggers that lead to successful sales may be generated locally, may be pushed to local systems from a centralized system, or a combination thereof. Not all of the numerous examples of patterns and triggers may be presented here; however, the Applicant believes that the representative examples of patterns and triggers may be readily modified by a person of ordinary skill based on the examples provided to accommodate preferences of local markets.

The system may be used to create generic searches for each price range and area of interest, for example. These searches may be scheduled to update themselves, such as daily updates, and may be recommended to specific buyers based on their input or the system's deduction of a buyer's price range and other criteria, based on buyer activity on the personalized website. Searches may be provided on a timely basis without agent input by establishing a number of these generic, periodically updated searches for real estate in your community, increasing responsiveness and reducing lost opportunity time for the agent, who can concentrate on active buyers in a purchase phase of the buying cycle.

A buyer receives a very timely introductory email and updated listings by email, periodically. A personalized website is provided that is customizable and may offer special features that anticipate a leads needs and desires, based on activities of the lead on the personalized website. Advertisers and referrals may be featured on the website. Statistics may be kept for the number of clients sent to advertisers and referrals from personalized websites. (These may be a source of revenue.) Periodic marketing messages may be customized and delivered on a schedule. Each electronic message may offer an opportunity to quickly access their own personalized website to search for more information, to search for more houses, or to re-customize their own search criteria or website. All of the actions taken may be monitored and used for providing alerts to an agent/broker.

In one example, the system provides the agent a customized activity reports and alerts. An updated task list is prepared periodically for agent follow-up with suggestions of actions to take and urgency, which are based on historical interactions between the system and a buyer or buyers.

In one example, interest by one buyer in a property causes the system to alert the agent to other buyers with similar interests that might be interested in the same property. For example, an automated messaging system may prepare and release, with or without authorization of the agent, an email to other buyers who may be interested in the same property. The system may provide the buyer with an email of similar properties to one viewed and selected by the buyer as a property of interest. In this way, the system acts as a virtual agent to the buyer, assisting with the buyer's search.

The system provides activity reports for each lead and records links to each property viewed by the lead and may offer statistics on the length of viewing, the number of photos of the property viewed, and any notes entered by the lead on the system about the property. The system may use this information to further tailor communications from the system to the lead, such as suggesting similar properties (even if the properties do not fit within the leads specific search criterion) or neighborhoods.

The system may suggest actions for a broker/agent to take by campaign and by lead. In one example, the system suggests who to mail, email or call and why. For example,

A lead, who has looked at emails more than 3 times during the past week, has saved one or more properties as being of interest during the past week, and has not spoken to or visited with the agent during the past week may be flagged for a telephone call or email or both within a specified time period. In another example, a lead, who has saved 3 or more properties during the past three days, has logged into their web account three or more times during the past three days, and is local may prompt an alert to an agent to schedule an appointment with the lead for visiting homes of interest to the lead. In yet another example, a lead who has not looked at emails for more than 30 days and has not saved a single property as being of interest, may be flagged for a telephone call by an assistant or a letter by regular mail, because emails might not be reaching the lead, or the lead may have lost interest in a home search. The example letter below may be used to reestablish such contact or to determine further interest, for example.

The system may include a contact management system that may include custom email and drip email campaigns.

CMAs may be provided by the system. The system may provide an IDX. The system may wirelessly synch to cell phones or portable computing devices. The system may provide account access by an agent's or broker's assistants. The system may provide for direct mail campaigns to all or a select portion of the lead database.

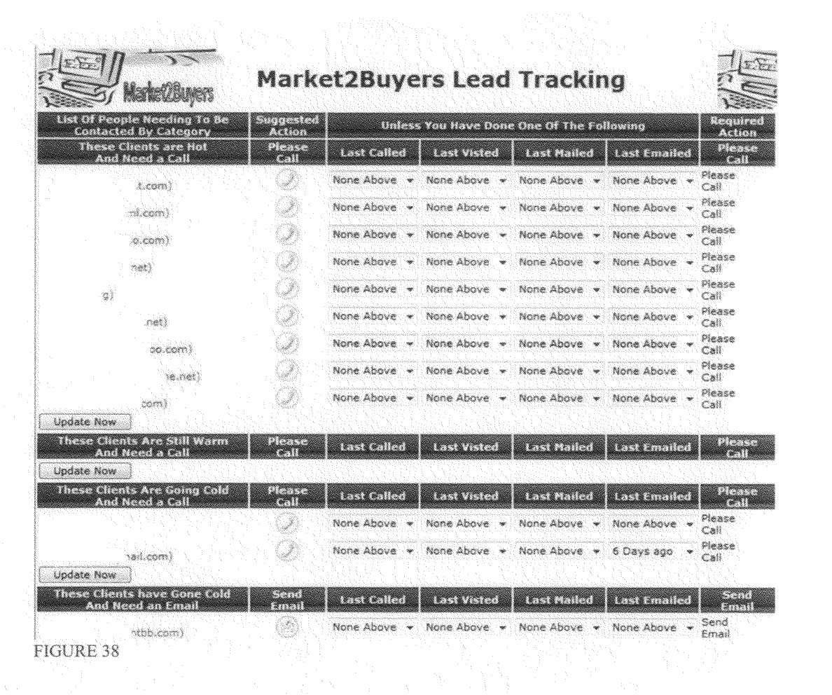

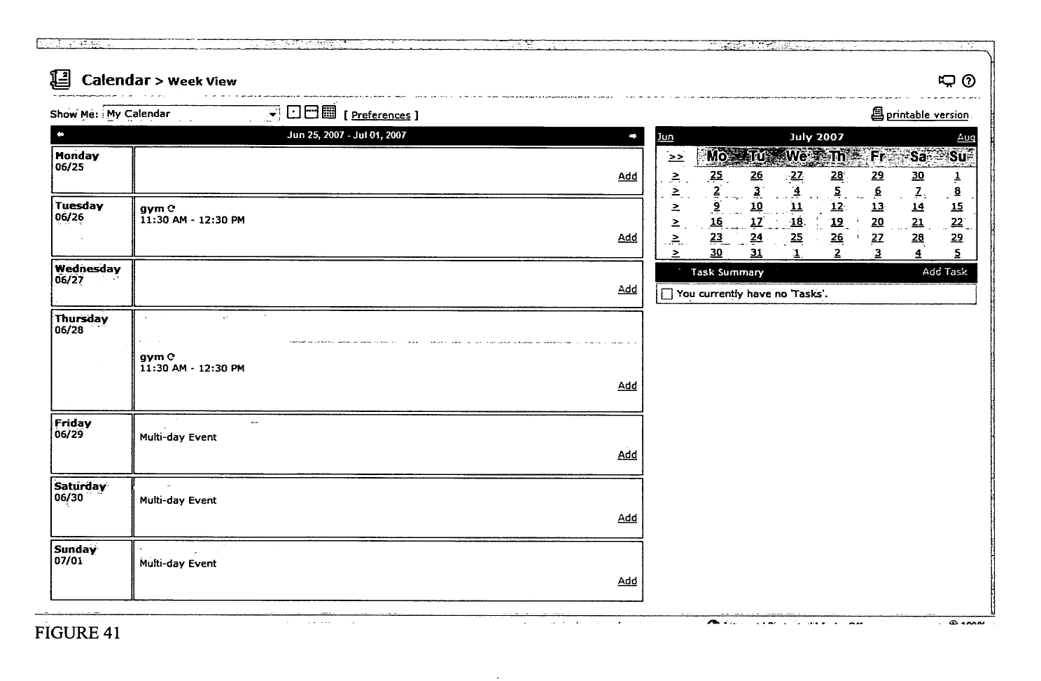

The system may provide a fully customizable website, such that the look and feel is what the agent and/or the buyer wants. A calendar and appointment function may be incorporated in the system that provides client relationship management (CRM) functions, such as shown in FIG. 41. A CRM window may show a contact history, such as shown in FIG. 38, for example.

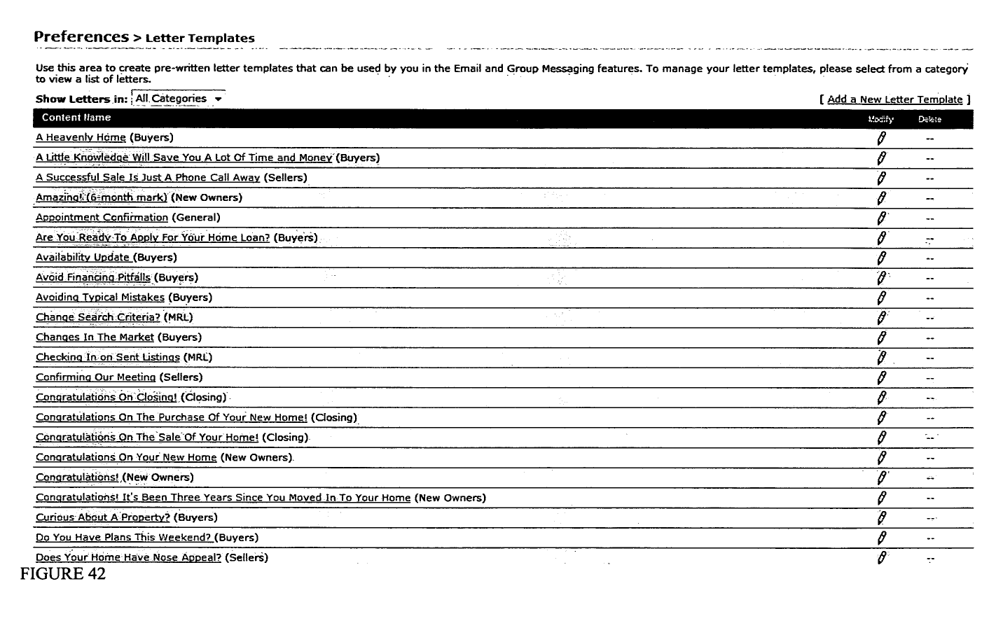

The system may include pre-written letters and scripts for use in telephone calls, and the system may suggest when the time is right to contact specific buyers by email or telephone. For example, FIG. 42 shows a list of some pre-written letters.

For example, the following letter and phone script may be used to requests feedback from a clients, who initially showed some interest but recently failed to look at emails sent to them for a specified period (such as 7, 10, 30 or any number of days set by default, updated by the system, set by an agent or set using input or pas activity of a specific buyer.).

### Letter

Dear {contact.fullname}:
Just a short note to confirm that you are still receiving the updated home listings I have been sending to your email address. If you have any problems viewing them, be sure to let me know so I can resend the information by email or fax, or deliver a printed copy to you.
At this time, I would also like to know if you are interested in personally touring any of the properties you've seen or if you would like to modify any aspect of your listing search criteria.
I can modify the criteria for you or you can log-in to your listings alert web site at [website address] with your user name {contact.bstusername} and password {contact.bstpassword} and make changes yourself.
Our goal is help you with the best information presented to you in the manner that works best for you.
Please let any of us at the [name] Team know how we can best be of assistance.
Thanks for the opportunity to be of service.

### Script

Hi [name] its {your name} calling from the [name] Team. I'm calling to confirm that you are still receiving the updated home listings I have been sending to your email address.

### If yes:

Are they what you are looking for?

### If yes:

Do you know you can save the ones you like? Would you like me to show you how?

### If no:

Then let's get your search criteria changed.
ALL: I appreciate your using our service. If you have any questions in the future don't hesitate to email me at ______ or call me at ______. If I am not available you can leave a message, and I will return you call within 24 hours.

For example, if a buyer is looking at one or two listings per day, each day, including weekends, and suddenly stops looking at listings for three straight days, then the system might suggest a telephone call using the script. However, if a buyer has been looking at a few listings per week, mostly on weekends and fails to do so in a 30-day period, then a letter by regular mail may be suggested by the system. These heuristic algorithms may be as complicated or simple as desired and may increase in specificity and complexity overtime. In general, activity of leads may be classified over time to place a particular lead in a particular category of leads, subject to the same heuristic algorithms. Alternatively, an agent may set up campaign and classify leads, directly, adjusting the alerts to the agent and outputs sent to the lead.

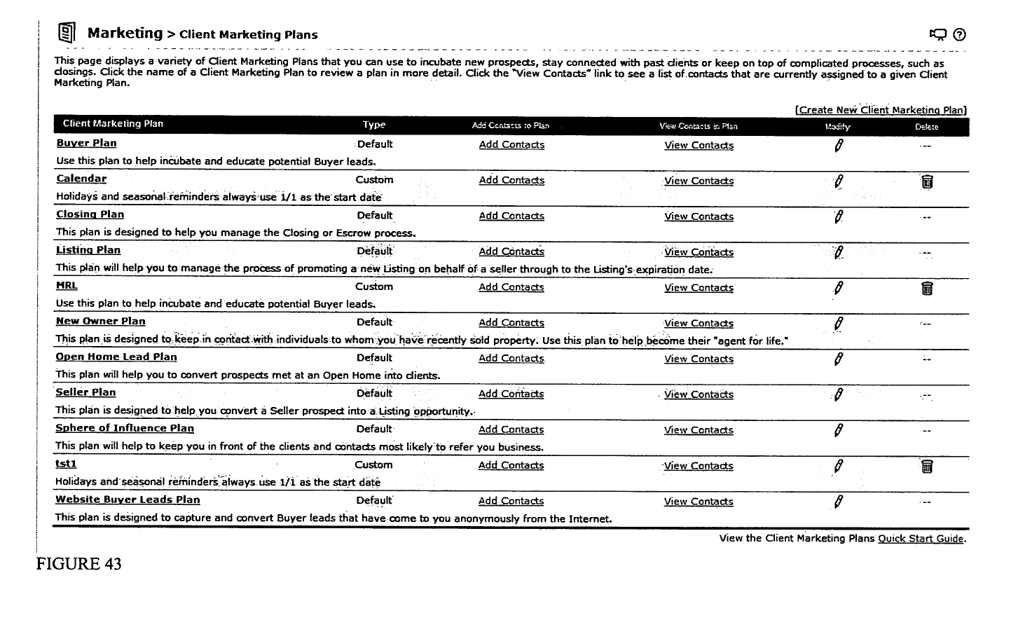

A series of email drip campaigns may be fully customizable by you and/or the buyer, either on a campaign-by-campaign basis or on a client-by-client basis. A list of some campaigns are shown in FIG. 43, for example.

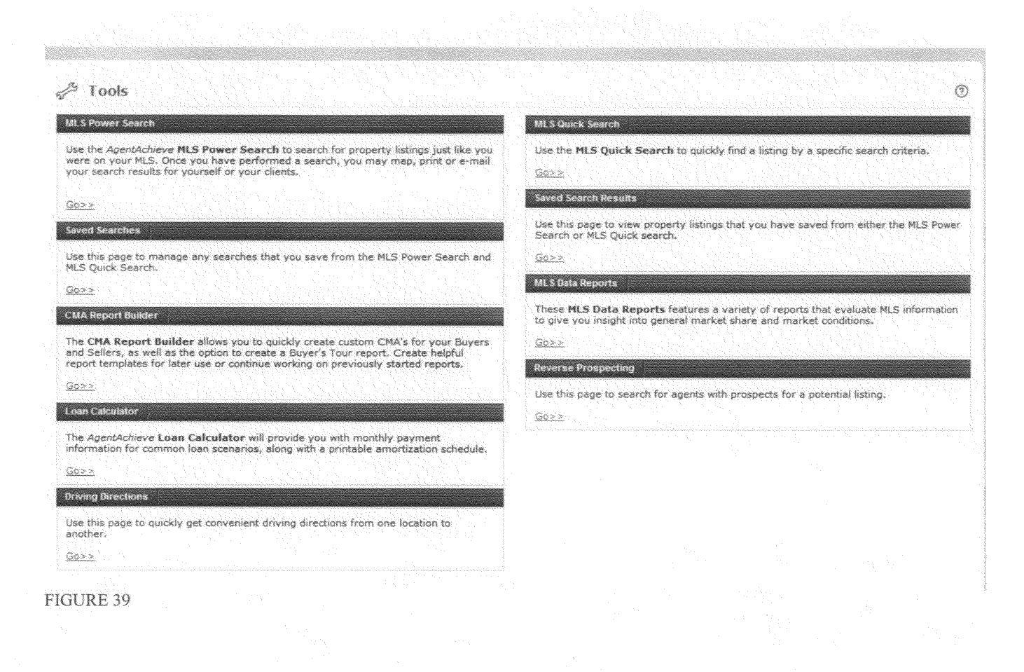

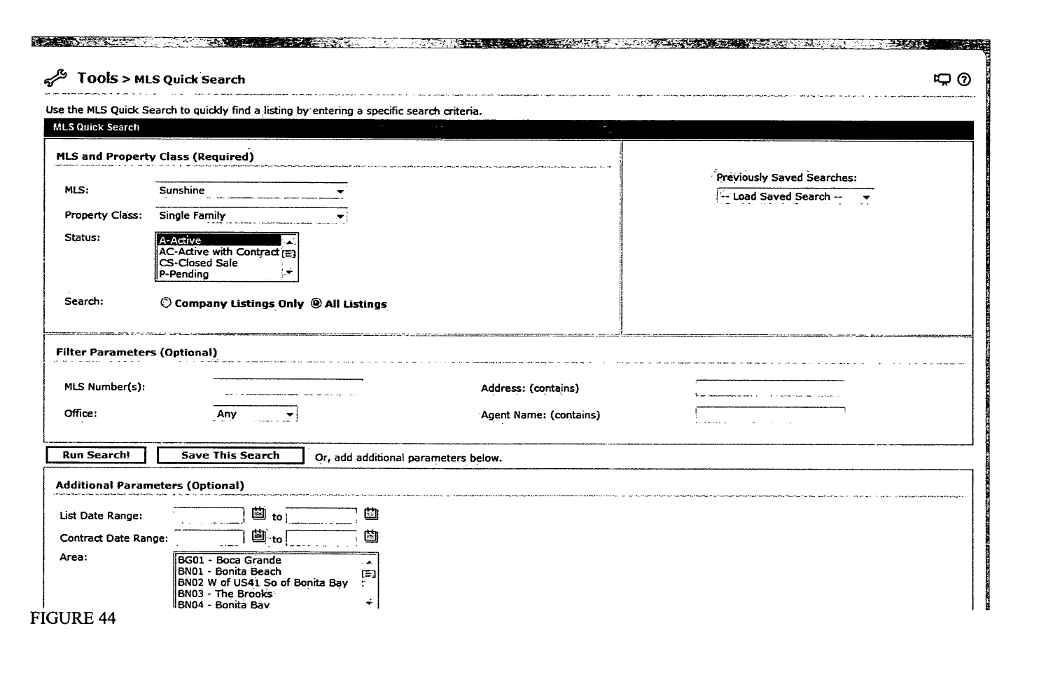

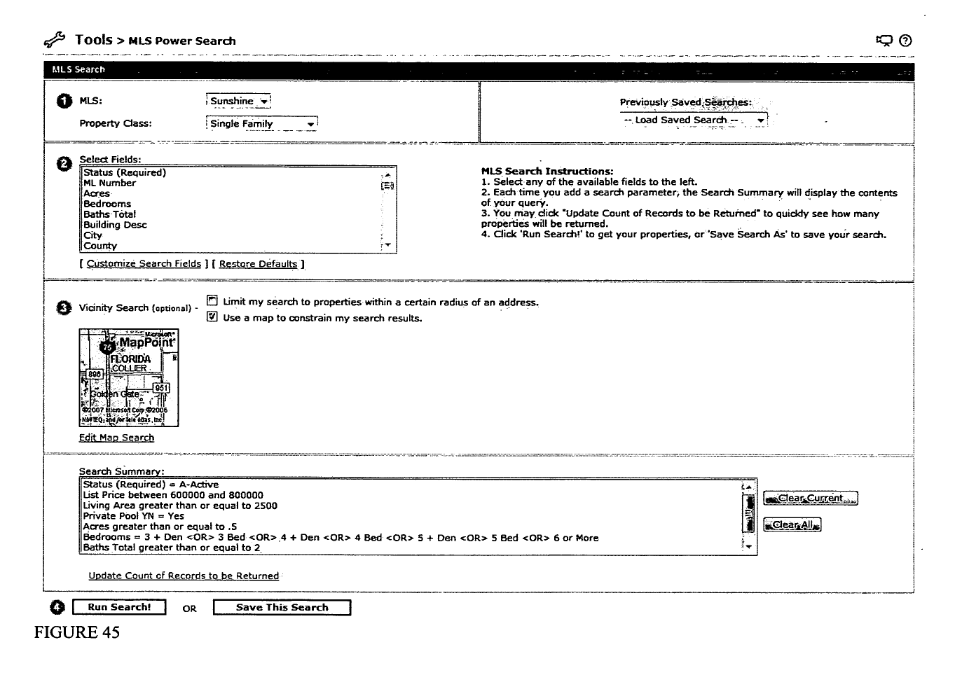

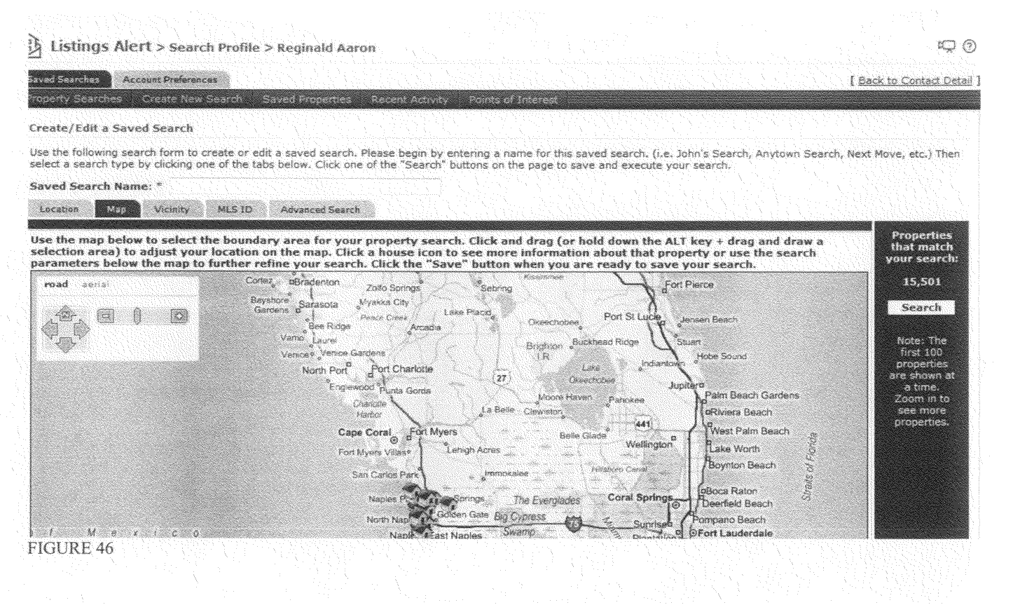

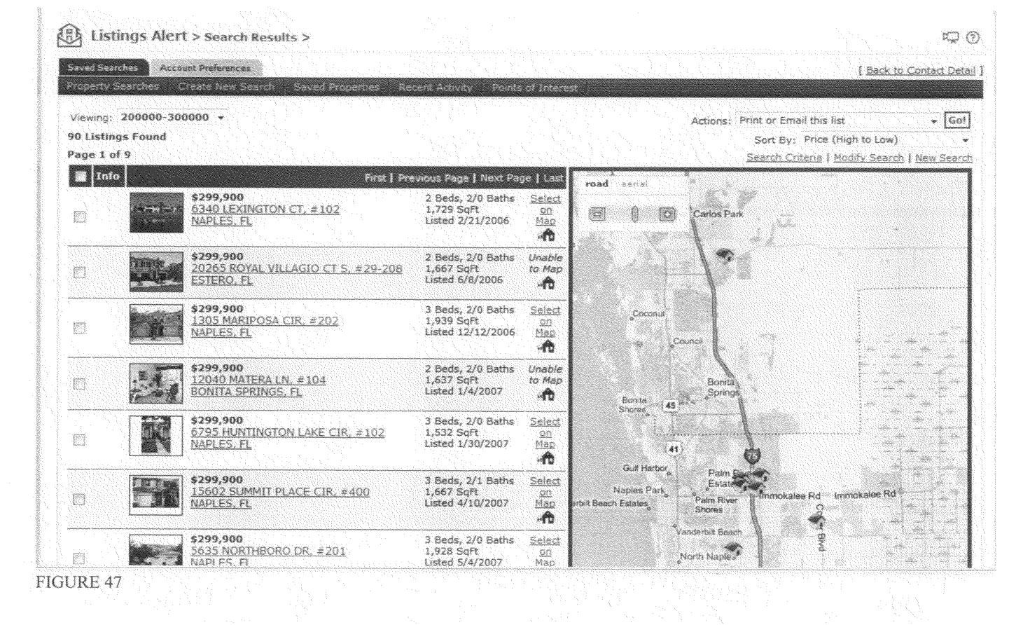

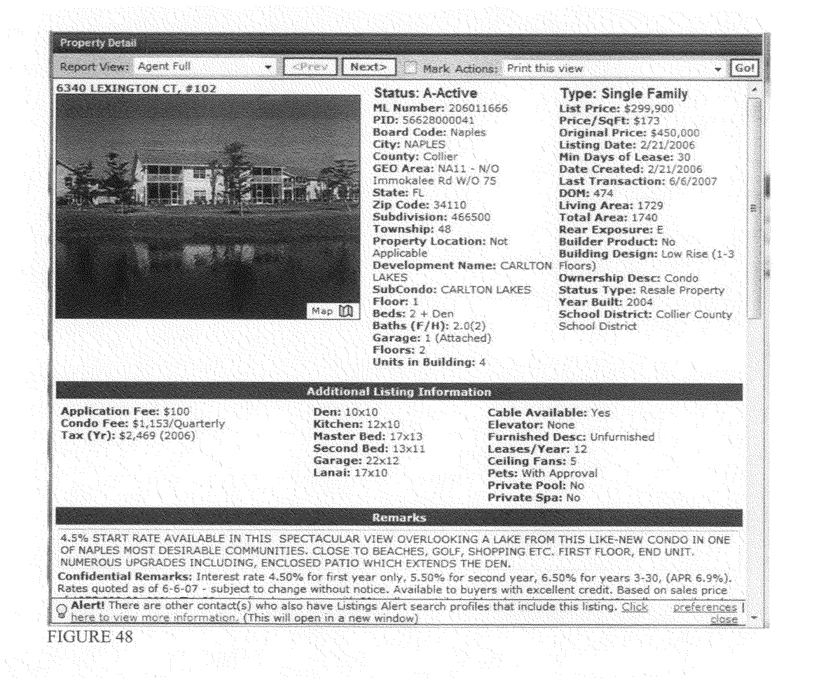

The system may include IDX, mapping and search capabilities. Searches may include maps, restricted vicinity searches, customized options. Search entry panels are shown in FIGS. 44 and 45, for example. All searches can be saved, all searches can be redirected to other clients. An example of a graphically displayed result of a search is shown in FIG. 46, which allows a boundary to be selected for limiting search results. In this example, the search allows the user to graphically select areas using maps for inclusion or exclusion from a search. Search results can be mailed out to people in and without the system, such as using the facility shown in the example of results in FIG. 47. For both you and your clients, search results may display photos and mapping information in an easy-to-use and easily understood manner. Selecting a search result may bring the viewer to a multiple listing service page, such as the page shown in the example of FIG. 48. Multiple views of search data give you the ability to generate as much or as little detail and as many or as few photos as you wish, client by client, property by property. FIG. 39 illustrates some tools available in one example of the system.

In one example, leads may be entered by importing leads from a database such as ACT! or Top Producer or using a CSV file or some other format of file. Leads may be manually entered based on call logs. Preferably, the leads are imported directly from internet forms. The system may purge, periodically, unproductive leads from the system database that do not fit a pattern of an actual prospective buyer.

For example, the system may be used to set up email alerts and listing alerts for the buyer and the broker. A personalized listing alert account for each buyer provides the buyer with an interactive, customizable email alert system that sends alerts about properties that are of interest to the buyer. The broker is provided with reports not only about the criteria selected by the buyer but also a record of those properties selected by the buyer for viewing, whether the buyer saved the property to a saved properties folder or altered the search criteria after receiving an email alert. Furthermore, the system can show how the buyer has evolved over time. Has the buyer ruled out certain neighborhoods? Has the price range of homes of interest increased over time or decreased? Is there a trend developing that can predict the size, location, price range or amenities of interest to a prospective buyer? Where in the process is the buyer? Has the buyer started to contact mortgage brokers or other lending sources? Has the buyer prequalified for a mortgage? Is it time to contact the buyer and suggest a tour of some homes? The system may be capable of answering these questions for the broker, allowing the broker to concentrate on those buyers who need direct contact with the broker, while establishing a dialogue with those buyers still in one of the research phases.

Alternative combinations and variations of the examples provided will become apparent based on this disclosure. It is not possible to provide specific examples for all of the many possible combinations and variations of the embodiments described, but such combinations and variations may be claims that eventually issue.

What is claimed:

1. A method of lead incubation, comprising:
establishing information about a plurality of leads in a system of lead incubation and contacting each of the plurality of leads to establish interaction between a plurality of the plurality of leads and the system;
tracking interactions of the leads with the system;
updating information about the leads captured in the step of tracking interactions;
defining alerts for each of the plurality of leads;
alerting an agent to take a suggested action based on the steps of tracking, updating and defining.

2. The method of claim 1, further comprising:
classifying leads into a plurality of categories, wherein the step of alerting presents the suggested action by categories.

3. The method of claim 1, wherein the step of tracking includes:
using a hidden pixel to track viewing of page on a website accessed by one of the plurality of leads.

4. The method of claim 1, wherein the step of tracking includes:
establishing a unique, personalized website for a plurality of the plurality of leads; and
providing a unique userid to each of the plurality of the plurality of leads, such that access to the unique, personalized website by a person using the unique userid is identified and recorded.

5. The method of claim 4, wherein the step of tracking includes:
capturing the viewing of a listing from a multiple listing service site using the unique, personalized website.

6. The method of claim 4,
wherein the step of establishing and contacting includes sending each of the plurality of leads an email containing an unique URL corresponding to a personal, customized website for each of the plurality leads.

7. The method of claim 6, wherein the step of tracking includes:
determining when an email is read;
determining when the website associated with the unique URL is accessed or how often the website associated with the unique URL is accessed or both thereof;
determining when a listing is viewed or how often a listing is viewed or both thereof; and
the step of updating includes recording information relating to each of the steps determining during the step of tracking.

8. A system for lead incubation by a real estate agent or broker, comprising:
a subsystem for capturing information about leads;
a subsystem for tracking interactions between the leads and the systems;
a subsystem for scheduling prepared telephone scripts, emails, letters, or combinations thereof; and
a subsystem for alerting the agent or broker to contact one or more of the leads, wherein the subsystem for capturing information about leads provides for entry of leads into a database directly by a person, automatic porting of leads from a file or CRM, automatic entry of leads from an internet form, or any combination thereof; the subsystem for tracking interactions includes a personalized website at a unique identifier for each of leads, determining when an email is read by each of the leads, recording the viewing of one or more listings by each of the leads or any combination thereof; and the subsystems for scheduling and alerting adjusts the alerts for each of the leads based on activity of the leads tracked in the subsystem for tracking and the information captured in the subsystem for capturing.

9. The system of claim 8, wherein the subsystem of alerting comprises:
defining a plurality of categories for leads;
assigning leads to one of the plurality of categories; and
instructing the real estate agent or broker of a follow-up action to take for each of the plurality of categories having at least one of the leads assigned thereto.

10. The system of claim 9, wherein the step of assigning leads compares information obtained about each of the leads in the subsystem for tracking with the definition of each of the plurality of categories defined in the step of defining categories, such that one or more of the leads are assigned to one of the plurality of categories only if information obtained about a respective one or more of the leads fits the definition defined in the step of defining categories.

11. The system of claim of claim 10, wherein the definitions of each of the categories is initially defined by system defaults.

12. The system of claim 11, wherein the system defaults are customizable by the real estate agent or broker.

13. The system of claim 12, wherein the definitions of each of the categories is adjusted by an adjustment subsystem.

14. The system of claim 13, wherein the adjustment subsystem recommends to the real estate agent or broker adjustments to the definitions based on the number of leads assigned to one or more of the plurality of categories.

15. The system of claim 13, wherein the adjustment subsystem recommends to the real estate agent or broker adjustments to the definitions based on response entered by the agent, determined by the subsystem for tracking or both thereof.

16. The system of claim 15, wherein the adjustments to the definitions are based on responses entered after contact with leads by phone, email or in person visit.

17. The system of claim 15, wherein the adjustments to the definitions are based on responses determined by the subsystem for tracking.

18. The system of claim 17, wherein the responses determined by the subsystem for tracking upon which adjustments to the definitions are based, include statistics about the responses of leads tracked by subsystem for tracking including rate of email opening, rate of personalized website viewing, rate of listing viewing, rate of listings saved, or rate of requesting showings, wherein each of the rates may be determined over time period defined in the system, defined by the agent or both thereof.

19. The system of claim 8, wherein the subsystem for scheduling includes an interface for leads to enter preferences; and entering preferences adjusts the scheduling of prepared telephone scripts, emails, letter, or combinations thereof.
